(19) United States
(12) Patent Application Publication
(10) Pub. No.: US 2007/0297947 A1
(43) Pub. Date: Dec. 27, 2007

(54) APPARATUS AND METHOD FOR FLUID DELIVERY TO A HYBRIDIZATION STATION

(75) Inventors: Jeff Sommers, Pearland, TX (US); Tiecheng Zhou, Pearland, TX (US); Justin Patten, Pearland, TX (US)

Correspondence Address: INVITROGEN CORPORATION;C/O INTELLEVATE, P.O. BOX 52050, MINNEAPOLIS, MN, 55402, US

(73) Assignee: INVITROGEN CORPORATION, Carlsbad, CA (US)

(21) Appl. No.: 11/748,680

(22) Filed: May 15, 2007

Related U.S. Application Data
(63) Continuation of application No. 10/616,505, filed on Jul. 9, 2003, now abandoned.
(60) Provisional application No. 60/395,954, filed on Jul. 15, 2002.

(51) Int. Cl. B01L 3/00

(52) U.S. Cl. 422/100

(57) ABSTRACT

A hybridization station for use in analysis of microfluidic chips includes a spring loaded chip interface subassembly that urges the loaded chip onto the fluidic loop connections when activated.

### CROSS-REFERENCE TO RELATED APPLICATIONS

This application claims benefit of U.S. Provisional Application No. 60/395,954, filed Jul. 15, 2002.

### STATEMENT REGARDING FEDERALLY SPONSORED RESEARCH OR DEVELOPMENT

N/A

### BACKGROUND

A biochip or microarray may be a two or three dimensional array on which molecules of known composition are placed in a site-specific manner. Because each array element may have unique chemical or physical characteristics, interaction of a sample, such as a DNA molecule of unknown sequence, with each element of the microarray may produce a signature pattern sufficient to identify the sample. A microarray may also be used to compare the signal pattern of the sample with a set of known patterns to identify whether the sample matches one or more of the known patterns.

A biochip may comprise known sequences of oligonucleotides attached to a surface of a biochip in a two dimensional format. Thus, the sequence of each oligonucleotide at each element of the biochip is known. Microarrays are powerful tools for use in wide applications in diverse areas of molecular biology, such as gene expression, single nucleotide polymorphism (SNP) detection, and mutation detection. Each of these applications requires specific recognition of a probe sequence by a target sequence in a sample containing tens of thousands of DNA or RNA molecules (gene expression) and/or high sensitivity and accurate detection of single base mutations (SNP detection). One method of using the biochip is to hybridize a sample DNA to the oligonucleotides on the biochip. Following hybridization, the signal pattern of the sample DNA is analyzed. Analysis of the hybridization pattern is tantamount to analysis of the sample DNA. Because each element of the microarray can simultaneously probe a sample, the microarray is an efficient vehicle for performing highly parallel analyses.

Hybridization stations have been developed to facilitate and to automate the analysis of microarrays. There is still a need however, for apparatus and methods of high throughput, automated analysis of microarrays.

### SUMMARY

The present disclosure may be described, in certain embodiments, as an apparatus for delivering fluid or fluids to a biochip, or an apparatus for conducting reactions on a biochip or microarray. In certain embodiments the apparatus includes one or more fluid circuits, and each circuit includes a first fluid conduit for delivering fluid to a biochip cartridge; a second fluid conduit for delivering fluid from the biochip cartridge; a pump for propelling fluid through the circuits; and a movable chip cartridge interface assembly that includes a chip cartridge guide; a heating/cooling element; and an inlet port and an outlet port; wherein, when the chip cartridge interface is in the engaged position during use, the inlet port and outlet port are urged against the inlet conduit and outlet conduit respectively by a spring; and further wherein the chip cartridge assembly is disengaged from the fluid conduits by compression of the spring.

The preferred apparatus is configured to accept a biochip cartridge and in certain embodiments includes one, two or more chip cartridges. In preferred embodiments a biochip cartridge includes an inlet port for receiving the inlet conduit; an outlet port for receiving the outlet conduit; and a gasket seal adjacent each inlet port and each outlet port; wherein when a chip is placed in the cartridge during use, the inlet port, outlet port and chip form a closed fluid loop within the cartridge. The inlet conduits and the outlet conduits of apparatus may also include probes configured to connect the inlet conduit to the inlet port of the cartridge and the outlet conduit to the outlet port of the cartridge when the chip cartridge assembly is in the engaged position. The probes may be made of any suitable material, including but not limited to ceramic, polymer or metal, and in preferred embodiments are stainless steel posts. The first conduit and the second conduits are preferably connected to a reversing valve effective to control the direction of flow of fluid across the biochip during use.

An aspect of the present disclosure is the placement of a filter within the gaskets of the inlet and outlet ports. This arrangement makes the use of the device much more convenient for a user who does not have to separately purchase and/or install filters within the chip cartridge. The filter may be of any suitable material and is preferably a stainless steel frit. The filter is placed in the center of the gasket and is held in place by friction during use.

It is an aspect of preferred embodiments of the disclosure that the apparatus includes a movable chip cartridge interface that is moveable from a disengaged to an engaged position. A chip cartridge inserted in the system is held in the engaged position, and in connection with the conduits by the force, preferably downward force, of a spring. The cartridge is disengaged by compression of the spring, and the spring is preferably compressed by a motor to disengage the chip cartridge assembly. In preferred embodiments the motor is connected to a slotted link effective, when the motor is actuated, to move the biochip cartridge assembly against the force of the spring effective to disengage the chip cartridge from the inlet and outlet conduits. Any motive force may be used to compress the spring, including an electric motor, a hydraulic or pneumatic system or even a manual system, but in preferred embodiments a DC gear motor is used. The apparatus may further include an inductive proximity switch effective to detect the position of the chip cartridge assembly.

The apparatus of the disclosure may also include one or more fluid reservoirs in fluid communication with the fluid circuits. In certain embodiments each fluid loop includes a reservoir and a reversing valve, and in certain embodiments, the apparatus includes a sample holder tray with tube holders and outlet holes for connection of tubing to connect the fluid loops to tubes in the tube holders.

The apparatus may also include a master module, and a plurality of fluid loops for delivering fluid to a biochip cartridge and wherein the master module includes a plurality of reservoirs each connected to a port of a first multiport valve and wherein each fluid loop is connected to a port of a second multiport valve such that fluid from any reservoir connected to the first multiport valve may be delivered to any selected fluid loop. In certain embodiments, each fluid loop may include a three port valve configured such that fluid may be delivered to two biochip cartridges within each fluid loop. In this way, the delivery of reagents may be automated or programmed into a computer connected to the apparatus for control of delivery of agents to the biochips. The apparatus may thus include a computer for controlling the pump, heating/cooling element, and valve systems of the apparatus, and a user interface connected to the computer.

The present disclosure may also be described in certain embodiments as a fluidics station including: a housing; one or more movable chip cartridge interface assemblies contained within the housing including: a chip cartridge guide configured to hold two chip cartridges; a heating/cooling element; and an inlet port and an outlet port; a plurality of fluid circuits including tubing, valves, pumps, and fluid reservoirs configured to deliver fluids to and from the chip cartridges; a processor to control the delivery of fluids to individual chips and to control the heating/cooling elements; and a user interface to input commands to the computer; wherein each movable chip cartridge interface assembly is moveable from an engaged position to a disengaged position; wherein in the engaged position the chip cartridge is pushed by a spring to engage the fluid circuits through ports in the chip cartridge, wherein each port contains a gasket and in which the pressure of the spring compresses the gasket to form a seal with the fluid circuit; and further wherein in the disengaged position the chip cartridge is separated from the fluid circuit by compression of the spring. Each gasket of the fluidics station preferably contains a flit filter embedded in the gasket.

An aspect of the present disclosure is also a biochip cartridge for processing a microarray on a biochip, including: an inlet port for receiving an inlet conduit of a fluidic circuit; an outlet port for receiving an outlet conduit of a fluidic circuit; and a gasket seal adjacent each inlet port and each outlet port; wherein each gasket seal comprises a filter embedded in the gasket; and further when a chip is placed in the cartridge during use, the inlet port, outlet port and chip cartridge form a closed fluid loop.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a diagram showing elements of a fluid circuit of a hybridization station.

FIG. 2A shows a T-junction. FIG. 2B shows a side view of a two T-junction stacked complex. FIG. 2C shows a side and top view of a two T-junction stacked complex. FIG. 2D shows a side view of a four T-junction stacked complex. FIG. 2E shows a side and top view of a four T-junction stacked complex.

FIG. 3A shows disposable elements of a hybridization station.

FIG. 3B shows a waste conduit and a reagent conduit attached to a fluid system.

FIG. 4 depicts an interconnection of air pinch valves to a fluid circuit.

FIG. 5 illustrates the operation of an air pinch valve.

FIG. 6 is a fluid circuit diagram of a hybridization station.

FIG. 7 shows a fluid circuit for priming a chip through Port A.

FIG. 8 shows a fluid circuit for priming a chip through Port B.

FIG. 9 shows a fluid circuit for purging air in a pump tube.

FIG. 10 shows a fluid circuit for circulating a sample across the chip.

FIG. 11 shows a fluid circuit for purging a sample to the reservoir.

FIG. 12 shows a fluid circuit for washing a chip.

FIG. 13 illustrates the elements of a temperature control module.

FIG. 14A shows a temperature control unit in a closed state in which a temperature control unit interacts with the chip.

FIG. 14B shows the temperature control unit in the open state in which the temperature control unit is pivoted away from the chip to allow access to the chip.

FIG. 15A is one implementation of a tube pinching pump comprised of three solenoid operated pinch valves with a piece of flexible tubing; and FIG. 15B is a diagram of the timing signal driving the three pinch valves.

FIG. 16 is a diagram of the electronic circuit driving the solenoid operated pinch valves in FIG. 15A.

FIG. 17 shows experimental and theoretical curves of pumping rate as a function of driving frequency.

FIG. 18A is one implementation of a tube pinching pump that includes four solenoid operated pinch valves with a piece of flexible tubing; and FIG. 18B is a diagram of the timing signal driving the four pinch valves.

FIG. 19 shows an embodiment with a hybridization reactor in which two pinch valves are disposed on each side of the reactor.

FIGS. 20A and 20B are diagrams of one embodiment of a fluid circuit of a hybridization system. FIG. 20A is step 1, is configured for simultaneous priming of chip and sample loop, and FIG. 20B is configured for recirculation of a sample through a chip.

FIGS. 21A and 21B depict an embodiment of a fluid circuit for use in a hybridization system. In this embodiment, the 4-port 2-position valve to reverse flow is connected directly to the chip, so that bidirectional percolation is possible. FIG. 21A is configured for simultaneous priming of chip and sample loop, and FIG. 21B is configured for recirculation of a sample through a chip.

FIG. 22 is an embodiment of a hybridization station designed to process two chips in parallel.

FIG. 23 is an example of a chip cartridge.

FIG. 24 is a part of a chip interface subassembly.

FIG. 25 is an example of a fluid loop for a hybridization station.

FIG. 26 is an example of a fluid circuit or loop in which a single pump serves multiple chips.

FIG. 27 is an example of a wiring schematic for a two chip system with separate pumps for each fluid loop.

FIG. 28A is an example of a high throughput system

FIG. 28B is an example of a control schematic.

FIGS. 29A-D are examples of slave module flow configurations.

FIG. 30 is an embodiment of a chip interface sub-assembly in the down, or activated position.

FIG. 31 is an example of the subassembly below the chip interface subassembly in an embodiment of a hybridization station.

FIG. 32 is a lower view of the assembly shown in FIG. 31 as it interacts with the fluid post block.

FIG. 33 is an alternate view of a hybridization station.

### DETAILED DESCRIPTION

The devices and methods disclosed herein may be described as fluidics stations or in certain embodiments, hybridization stations and are particularly suited to the efficient use and analysis of biochips or microarrays. The disclosure includes apparatus in which some or all of the steps used in analysis of a biochip or microarray are automated. The stations of the present disclosure provide apparatus and controls for various functions related to microarray analysis including, but not limited to, temperature control, and control of fluid flow across the active surface of a plurality of micoarrays. A user interface provides the ability to subject one or more microarrays to preprogrammed cycles of time, temperature, reagent, and direction of fluid flow, or individual parameters may be selected by a user.

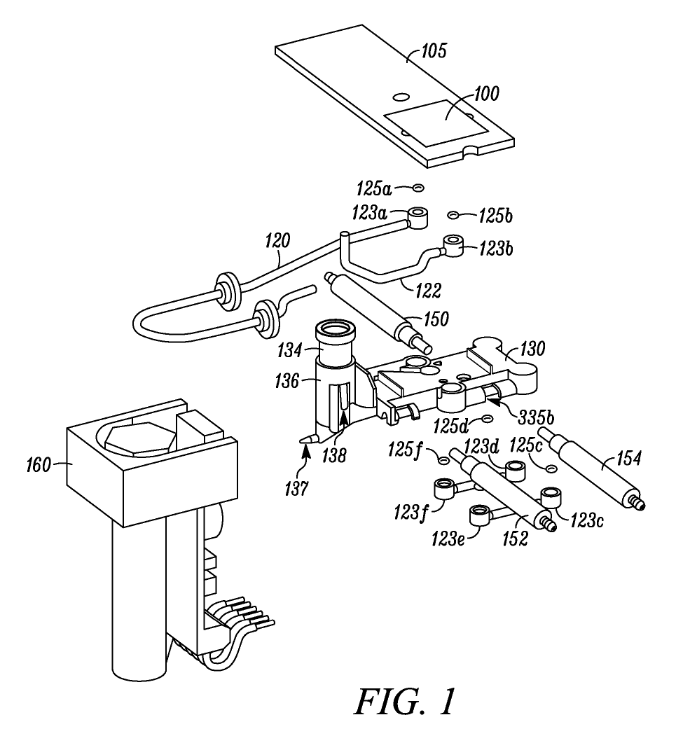

FIG. 1 shows the components of one implementation of a fluid circuit of a hybridization station (or apparatus). The fluid circuit may be used to transfer a test reagent or sample to a chip 100, to transfer reagents, water, buffers or reaction solutions to the chip 100, or to wash the chip 100. The chip 100 may also be referred to, without limitation, as a biochip, a DNA chip, or a microarray. In one implementation, the chip is a microfluidic device. The solution in each reaction chamber of the chip 100 can be circulated continuously, e.g., the chip reactions can be performed under flow conditions. Because of the dynamic fluid flow, mixing is facilitated between the sample and the target molecules on the chip. In addition, the fluid flow may be reversed across the chip by the use of a reversible pump mechanism or by the use of reversing valves. A chip 100 is attached to a chip holder 105. The chip 100 may contain nucleic acids such as deoxyribonucleic acid (DNA) or ribonucleic acid (RNA), or the biochip 100 may contain, among other things, peptides, carbohydrates, peptide nucleic acid (PNA), lipids, lipopeptides, carbohydrates, or combinations thereof.

Part of an example fluid circuit includes two conduits (120 and 122), a sample reservoir 134 and a chip 100. For example, in FIG. 1, conduit 120 is connected to sample reservoir 134 through a sample reservoir outlet 137. A second conduit 122 is connected to sample reservoir 134 through a sample reservoir inlet 138. The chip 100 is connected to conduits 120 and 122 forming a fluid loop. Conduits 120 and 122 may be fabricated from silicone rubber tubing, polypropylene, or stainless steel. In another implementation, the conduits may be fabricated from Teflon. The internal diameter of the silicone rubber tubing is preferably not greater than 0.03 inches to minimize the volume of fluid in the fluid circuit. In one implementation, the volume of fluid in the fluid circuit does not exceed twenty microliters. In another implementation, the silicone rubber tubing has a small internal diameter from about 0.010 inches to about 0.015 inches. The use of the term “about” herein is meant to have its ordinary meaning of “approximately” and is indicative of there being some inherent discrepancies in measuring devices, as well as differences in sizes of available materials. Therefore, depending on the thing measured and the manner of measuring, “about” may indicate that the number or quantity may include some uncertainty of ±1%, ±5%, ±10% or even ±20% in some instances.

During operation of the hybridization station, the chip 100 may communicate with external fluids. Such fluids may contain, for example, a DNA sample or reagents such as hybridization buffers. Although not shown in FIG. 1, chip 100 may contain two ports (Ports A and B) through which fluid may enter and exit the chip. To establish a sealed, leak-proof connection for fluid ingress to, and egress from the chip 100, an o-ring seal 125a is preferably placed between a T-junction 123a and one of the two ports of the chip 100. Likewise, an o-ring seal 125b is placed between a T-junction 123b and the other port of the chip 100 forming a second sealed channel through which fluid may enter and exit the chip. The chip 100 may be compressed against o-ring seals 125a and 125b forming leak proof fluid connections to chip 100. In one implementation approximately ten pounds of force is sufficient to compress the O-rings and provide tight leak proof seals at the points of contact with T-junctions 123a and 123b. In another implementation, the amount of force required to form a tight leak proof seal varies between 0.001 and 100 pounds. The hybridization station interfaces with a biochip through ports A and B.

A description of a biochip and a method of synthesis is described in WO 02/02227 A2 (Zhou et al., 2002), which is incorporated herein by reference for all purposes. For example, in one implementation of a hybridization station, a chip such as disclosed in WO 02/02227 A2 may be coupled to the hybridization station.

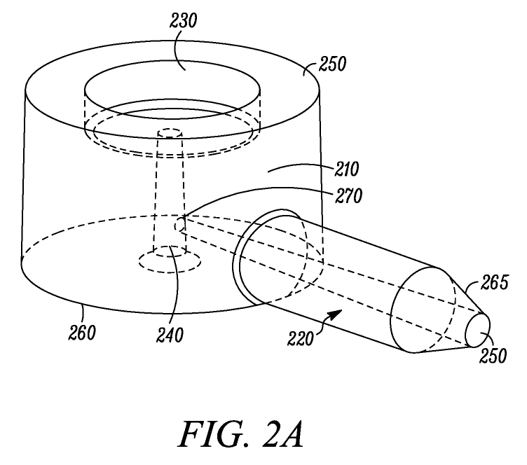

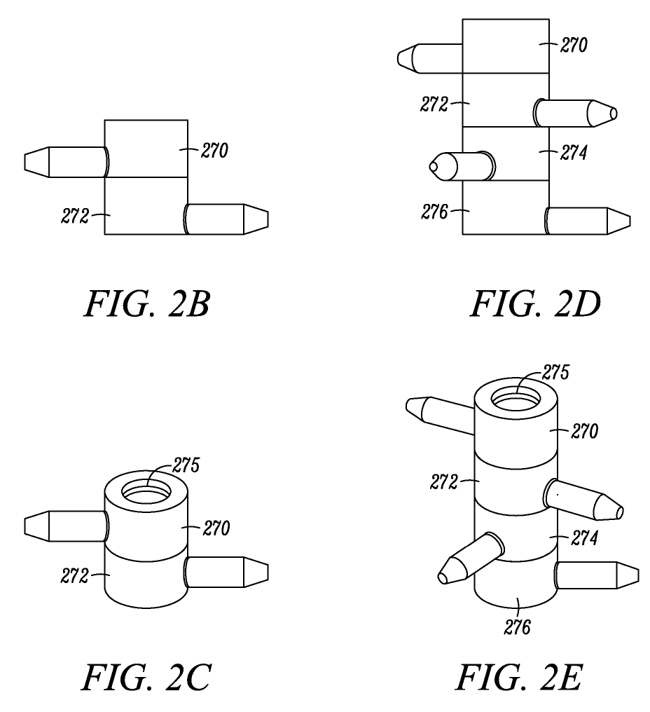

For the simultaneous processing of multiple chips, the use T-junctions are contemplated. A T-junction is shown in FIG. 2A. The T junction in FIG. 2A is comprised of a large cylinder 210 and a small cylinder 220. The large cylinder 210 includes a recessed portion 230 at one end 250 and a flat surface at the other end 260 of the large cylinder 210. The recessed portion 230 is dimensioned to accommodate an o-ring seal 125a-f. The large cylinder 210 includes a channel 240 through which liquid may flow. The small cylinder 220 includes a channel 250 through which liquid may flow. The large cylinder 210 and the small cylinder 250 intersect at intersection point 270. In one implementation, the large cylinder 210 and the small cylinder 220 are oriented such that the channels 240 and 250 intersect at an angle of approximately ninety degrees. In another implementation, the channels 240 and 250 may intersect at an angle of greater than or less than ninety degrees.

A T-junction may be fabricated from a material that is chemically resistant to the fluid circuit environment. Depending on the choice of material, the T-connectors may be efficiently fabricated using injection mold technology. Representative materials that are chemically resistant and compatible with injection mold technology include poly-ether-ether-ketone (“PEEK”) or polypropylene.

To connect a T-junction to the fluid circuit, a conduit such as silicone rubber tubing may be placed over the tapered end 265 of the small cylinder 220. Assume that a conduit is attached to tapered end 265 and fluid is flowing into tapered end 265 from conduit 220. Fluid may then flow from the conduit into fluid channel 250 and then into fluid channel 240. Once in the fluid channel 240 fluid may flow through channel 240 toward end 260 and/or toward end 250. The direction of fluid flow in the T-junction may be controlled by restricting fluid flow in the fluid channel 240. For example, preventing fluid from flowing in fluid channel 240 beyond surface 260 would cause the fluid to flow through the fluid channel 240 in the direction beginning at intersection point 270 and passing through the recessed portion of large cylinder 230.

Fluid entering one channel of a T-junction may exit the T-junction through either that same channel or through the second channel in the T-connector. By stacking T-junctions and selectively restricting fluid flow at specific points, multi-directional control of fluid transfer may be achieved, while minimizing required fluid volume. For example, fluid that enters a T-junction through fluid channel 250 may exit the T-junction through either end of fluid channel 240. T-junctions may be stacked on each other such that surface 260 of one T-junction abuts surface 250 of another T-junction.

FIG. 2B shows a side view of two T-junctions vertically stacked. In this figure, T-junction 270 is stacked on top of T-junction 272 forming a stacked T-junction complex. FIG. 2C illustrates that the recessed portion 275 of T-junction 270 is located at the top of the stacked T-junction complex. FIG. 2D shows a side view of four T-junctions vertically stacked. In this figure, T-junction 270 is stacked on top of T-junction 272, T-junction 272 is stacked on top of T-junction 274, and T-junction 274 is stacked on top of T-junction 276 forming a stacked T-junction complex. FIG. 2E illustrates that the recessed portion 275 of T-junction 270 is located at the top of the stacked T-junction complex. Fluid that enters a stacked T-junction complex through fluid channel 250 may exit the stacked T-junction complex at n+1 different places, where n is the number of T-junctions. By permitting fluid flow only through one of the n+1 different possibilities of fluid flow, T-junctions can be used to selectively transfer fluid from one conduit to another conduit. Other implementations may include reversing the direction of fluid flow such that fluid enters the T-junction through either end of the fluid channel 240. For example, fluid may flow into the fluid channel 240, into the fluid channel 250, and then into a conduit attached to the tapered end 260 of the small cylinder 220.

Referring back to FIG. 1, a fluid circuit of a hybridization station may include T-junctions, silicone rubber tubing, a sample reservoir, and a chip. T-junctions 123a and 123b provide an interface between the chip 100 and conduits 120 and 122. For example, assuming that rubber tubing functions as conduits 120 and 122, then one end of each silicone rubber tubing piece may be attached to a tapered end 260 of a T-junction 123. The two T-junctions 123a and 123b, in combination with O-rings 125a and 125b may be attached to Ports A and B of chip 100. A sample reservoir 134 may connect the remaining two ends of the conduits 120 and 122. In one implementation, conduit 120 is connected to a sample reservoir outlet 137, and conduit 122 is connected to a sample reservoir inlet 138. A closed fluid circuit may be created by placing a fluid barrier at the open ends 260 of the T-junctions 123a and 123b. In this case, the fluid transfer circuit may be defined by the first conduit 120 and associated T-junction 123a and o-ring 125a, the sample reservoir 134, the second conduit 122 and associated T-junction 123b and o-ring 125b, and the chip 100 and associated first and second ports.

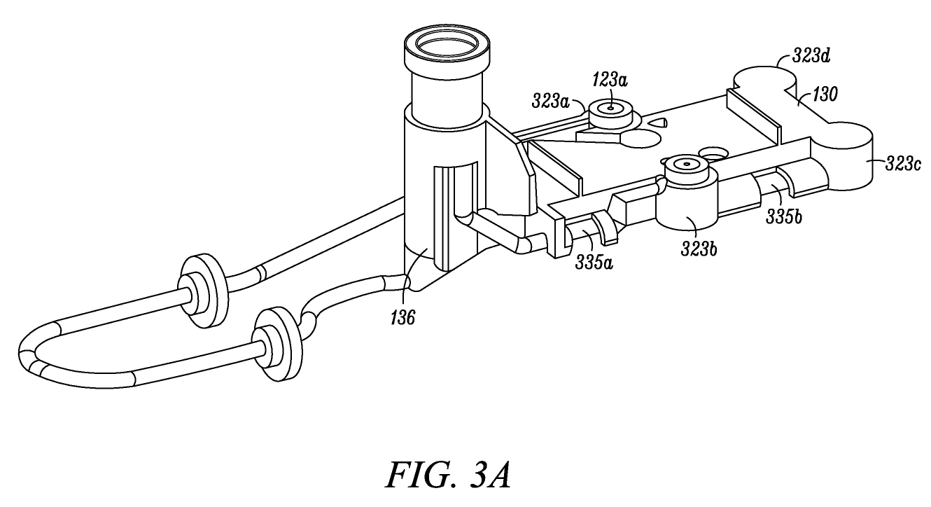

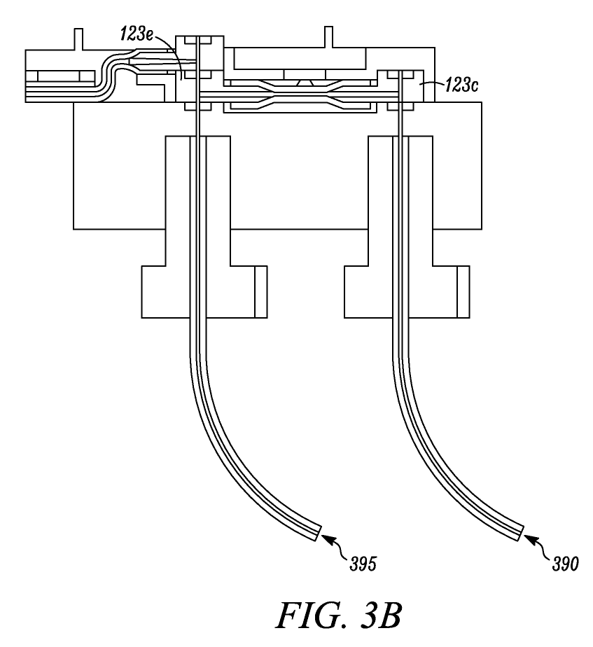

For ease of use, one implementation of the hybridization station includes a plastic molded dock 130. The dock 130 provides physical support for the fluid transfer circuit as shown in FIG. 3A. The dock 130 facilitates interfacing the fluid circuit with the hybridization station. The dock 130 includes T-junction acceptors (323a, 323b) which may accommodate one or more T-junctions 123a. One T-junction is present in each T-junction acceptor in the implementation shown in FIG. 3A. To block fluid flow in the fluid circuit, the dock 130 may include three pinch points. In another implementation, one or more pinch points may be utilized. A pinch valve is used to depress or pinch a conduit against a pinch point, and thereby prevent flow in the depressed conduit. Of the three pinch points, only two (335a and 335b) are shown in FIG. 3A. As shown in FIG. 3A, the pinch points 335a and 335b function as support for the silicone rubber tubing conduits. Pinch point 135c is located across the dock 130 from pinch 135a and provides support for conduit 120. The dock includes a sample holder 136 that provides support for the sample reservoir 134. Once placed in the plastic dock, the combination of the fluid circuit and the plastic dock may be manipulated as a single unit and placed in the fluid circuit of the hybridization station.

In addition to delivering the sample to the chip, the fluidic system may also provide input connections for introducing reagents to the chip 100, as well as output connections for providing a path for the removal of waste products from the chip 100. A conduit coupled to a T-junction. functions to interface the chip 100 to a fluid external to the chip 100. In one implementation, the conduit may be silicone rubber tubing. Other implementations include Teflon or stainless steel. As shown in FIG. 3A, one implementation of the dock 130 accommodates four additional T-junction for a total of six T-junctions. Two T-junctions are placed in acceptor 323a, two T-junctions are placed in acceptor 323b, and one T-junction is placed in each T-junction acceptor 323c and 323d. As shown in FIG. 1, T-junctions (123c and 123d) may be attached to both ends of an input conduit 152. A T-junction 123e with an o-ring 125e is placed in T-junction acceptor 323b, such that the o-ring 125e of T-junction 123e abuts T-junction 123b. Likewise, an o-ring 125f is placed in T-junction 123f, and T-junction 123f is placed in T-junction acceptor 323a such that o-ring 125f abuts T-junction 123a. Force is applied across the chip 100 and the T-junctions such that leak proof seals are created at o-ring junctions. In general, sealing between the T-components, chip, and manifold is achieved with o-rings. The fluid circuit is placed on a base, and the seals are compressed against the chip and the base with a pneumatic cylinder holding the TE module against the chip.

Returning to FIG. 1, the fluidics system may also include a pump 160. In one implementation, peristaltic pump 160 surrounds conduit 120. Because the peristaltic pump 160 contacts the exterior of conduit 120 to cause fluid to move through the system, the sample fluid does not contaminate the peristaltic pump 160. Moreover, the rotational direction of the pump may be changed. Thus, peristaltic pump 160 provides efficient mechanism to control the direction of fluid flow within the fluid circuit. In addition, the peristaltic pump 160 may function as a valve to close the conduit and thus prevent fluid from entering the sample reservoir outlet 137 during, for example, a washing step that increases the stringency of a hybridization reaction performed on the chip 100. Likewise, activation of pinch valve 154 will prevent fluid from entering the sample reservoir inlet 138. Assuming that pinch valve 154 and peristaltic pump 160 are in their respective closed positions, dilution of the sample should not occur as external fluid is introduced into the fluid circuit.

During its operation, a hybridization station may deliver external fluids to the chip 100. The external fluids may be used, for example, to facilitate discrimination of the hybridization reaction or to wash the chip. Additionally, during its operation, a hybridization station may provide for disposal of fluid from the system by routing fluid to a waste reservoir. As discussed previously, one implementation of the sample loop includes conduits 120 and 122 and associated T-junctions, the reagent reservoir 134, and the chip 100. Input conduits 142a and 142b and associated T-junction 123c and 123d permit external fluid to enter the system. By attaching reagent conduits to T-junctions, external fluids may be introduced into the fluid circuit. FIG. 3B shows a reagent conduit 390 attached to T-junction 123e. As shown in FIG. 3A, the dock 130 provides T-junction acceptors to accommodate T-junctions 123c and 123d. Similarly, by attaching waste conduits to T-junction 123e and 123f fluids may be removed from the fluid circuit. FIG. 3B shows a waste conduit 395 attached to T-junction 123e. T-junction acceptors 323a and 323b of dock 130 support T-junctions 123f and 123e, in addition to T-junctions 123a and 123b. Each T-junction acceptor 323 may be designed to accommodate two T-junctions: one T-junction that provides a connection to the chip 100 and one T-junction that provides a connection to a waste conduit.

When adding external fluid to the fluid circuit care is taken to prevent contaminating the external fluid source with DNA or other materials from a given test. Qualitative or quantitative analysis of the chip 100 may require disposal of all elements that come in contact with the sample DNA. Each element shown in FIG. 3A is fabricated from inexpensive materials such as plastics or other polymers. Thus, in one implementation, the fluid circuit shown in FIG. 3A is disposable, and thus cross contamination of DNA samples is reduced or eliminated.

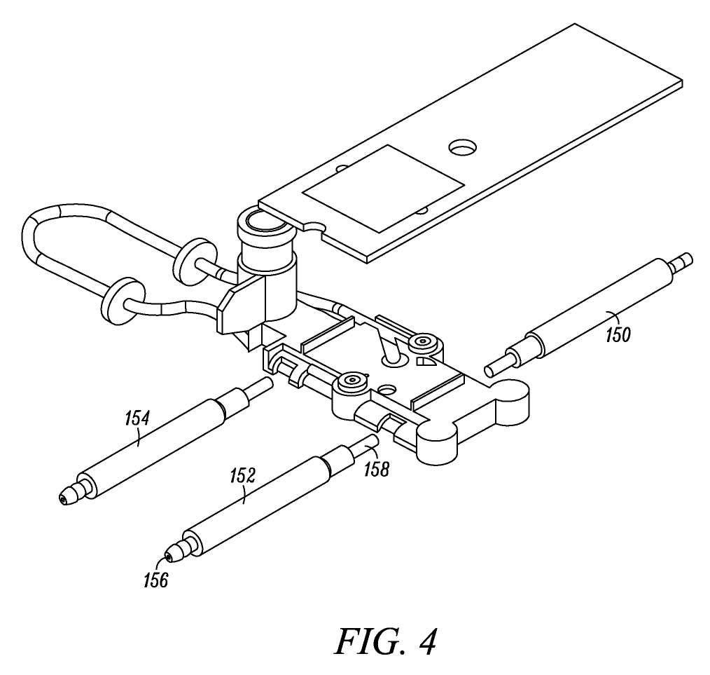

As shown in FIG. 4, to prevent DNA sample contamination of the external fluid source, pinch valves 150 and 152 are included in one implementation of a hybridization station. The fluid circuit is isolated from the other parts of the fluid system with miniature air cylinders pressing against the tubing on projections from the dock. By closing the cylinders, pinch valves prevent the flow of sample fluid into the manifold system, including the reagent input valves. When activated, pinch valves 150 and 152 isolate the fluid circuit from the external fluid source, and prevent fluid contact between the external fluid source and the fluid circuit defined by connecting conduits 120, 122, the sample reservoir 134, and the chip 100.

A pinch valve 154 is included to control the direction of fluid flow and to prevent contamination of the sample with external fluids. Activation of pinch valve 154 prevents fluid flow through conduits 120 and 122, and consequently fluid flow is limited to flow between the external fluid input source, the chip and the waste reservoir. Moreover, depending on its implementation, the pump could function as a valve to isolate the sample from the circuit fluid. For example, a peristaltic pump may be operated as a pinch valve to prevent contamination of the sample stored in the reservoir 134.

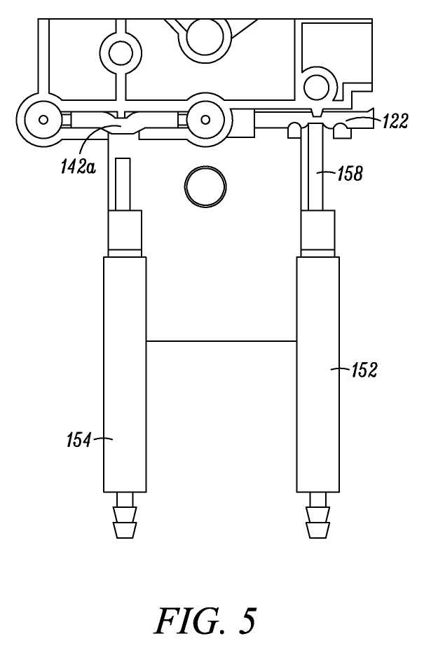

FIG. 4 illustrates the fluidics system combined with pinch valves 150, 152, and 154. In one implementation, air cylinders form the basis of pinch valves. As shown in FIG. 4, a pinch valve 152 comprises a hollow cylinder 154. One end 156 of the hollow cylinder 154 is adapted to receive pressurized gas. The other end of the pinch valve 152 comprises a solid cylinder 158 that is slidingly insertable into that end of pinch valve. The operation of one implementation of a pinch valve is shown in FIG. 5. When the valve is open, i.e., when the gas pressure inside the pinch valve 154 is less than 80 pounds per square inch, fluid is permitted to flow in the conduit adjacent to the pinch valve, i.e., conduit 142a in FIG. 5. In another implementation, the gas pressure may be in the range from approximately 1 to 1040 pounds per square inch. When the valve is closed, the solid cylinder 158 of pinch valve 152 depresses against the conduit adjacent to the pinch valve 152 sufficient to prevent fluid flow in conduit 122 of FIG. 5.

In another implementation the pinch valve may be a solenoid driven pinch valve such as Bio-chem Valve 072P2-PP473 from Bio-chem Valves, Inc. In one implementation, the pinch valve plunger may be a chisel-shaped plunger. In another implementation, the pinch valve plunger may have a cylindrical plunger with a flat pinch head. The plunger head should be shaped to reduce fluid flow when the valve is fully engaged.

The fluid circuit of a hybridization station as shown in FIG. 1 can be operated in various modes. In certain uses of the fluid circuit, the sample fluid may be circulated through the chip 100, the sample reservoir 131, and conduits 120 and 122. Additionally, external fluid may be introduced to the fluid circuit and delivered to the chip 100. For example, buffers of increasing stringency may be added to the fluid circuit to enhance mismatch discrimination in a hybridization assay. For example, a phosphate or TRIS-base buffer of low ionic strength may be introduced into the fluid circuit to discriminate mismatched hybridized base pairs. Dilution of the sample with the external fluid can be prevented by closing the sample valve 154 and using the peristaltic pump 160 as a pinch valve. Moreover, the fluid in the fluid circuit may be diverted to the waste reservoir.

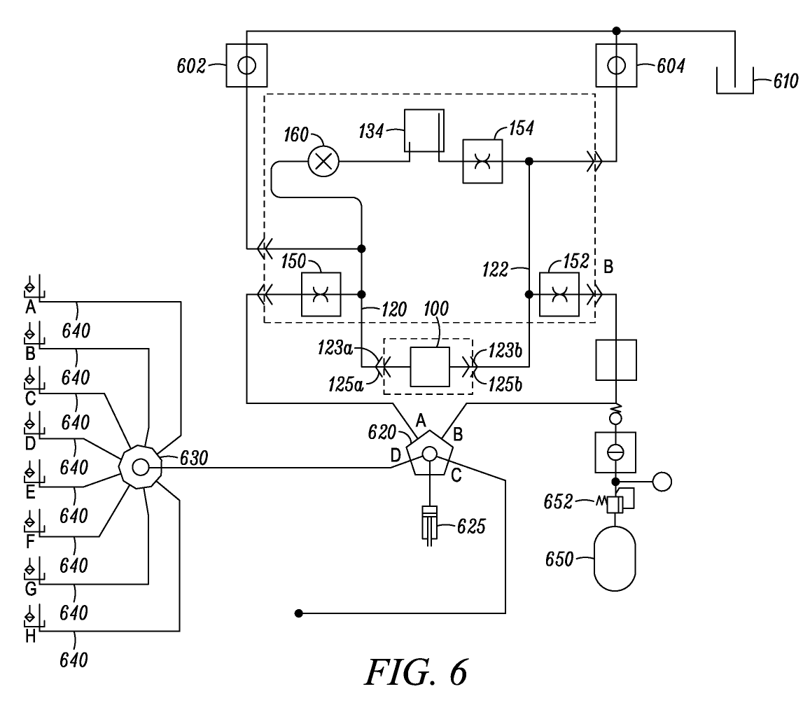

A fluid flow diagram of one implementation of a hybridization station is shown in FIG. 6. A fluid loop for circulating fluid through the chip 100 includes conduits 120 and 122 connecting the sample reservoir 134, the associated T-junctions 123a and 123b and o-rings 125a and 125b, and chip 100. The ingress of fluid to, and the egress of fluid from the fluid system is controlled by a series of valves. For example, waste valves 602 and 604 regulate the flow of fluid to the external environment. If at least one of the waste valves 602 and 604 are in the open state, fluid may exit the system and be deposited into the waste reservoir 610. Similarly, isolation valves 150 and 152 control fluid access to the system. If at least one of the isolation valves 150 or 152 is open, fluid may enter the system.

A reagent pump 625 and reagent pump valve 620 control entry of fluid to the fluid system. The reagent pump 625 may be, for example, a syringe pump. In the implementation shown in FIG. 6, the reagent pump is connected to a four position reagent pump valve 620. Position D of reagent pump valve is connected to one or more reagents 640 through a reagent selector valve 630. The reagent selector valve controls which reagent is to be added to the fluid system. The number of selectable reagents is limited only to the extent of the configuration of the reagent selector valve 630. Additionally, a multiple reagent valve may be connected to another multiple reagent system controlled by a multiple reagent valve, thereby increasing the number of selectable reagents introducible into a system.

To introduce a fluid into the fluid circuit, the reagent selector valve 630 is positioned based upon the selected reagent. The reagent pump valve 620 is oriented so that the reagent pump 625 is in fluid communication with the selected reagent. The reagent pump 625 draws a desired amount of the selectable reagent into the pump. Assuming that the fluid should enter the fluid system through isolation valve A 150, the reagent pump valve 625 is positioned so that the reagent pump 625 is in fluid communication with position A of the reagent pump valve 620. The reagent pump 625 then pumps the selected reagent into the fluid system through isolation valve 150. In order to pump fluid into the fluid circuit through isolation valve 152 the reagent pump valve 620 is positioned so that position B of the reagent pump valve is in fluid communication with the reagent pump 625. Similarly, if the reagent pump valve 620 is oriented such that position C of the reagent pump valve is in fluid communication with the reagent pump 625, then the selected fluid would bypass the chip 100 and be pumped to the waste reservoir.

The direction of fluid flow in the fluid circuit may be controlled by waste valves A 602 and B 604, sample pump 160, sample valve 154, isolation valves A 150 and B 152, reagent pump valve 620, and the reagent pump 625. For example, assuming that both isolation valves 150 and 152 and both waste valves 602 and 604 are closed, and sample valve 154 are opened, the fluid will be confined to a closed loop comprising the chip 100 and the sample reservoir 134 and connecting conduits 120 and 122. In this case the rotational direction of the peristaltic pump controls the direction of fluid flow in the fluid system. In another implementation the chip 100 may be washed by first isolating the sample reservoir 134 from the fluid system by closing the sample valve 154 and causing the sample pump 160 to function as a closed valve. Assuming that isolation valve 152 and waste valve 602 are closed, a selected reagent may be pumped through isolation valve 154, and into the waste reservoir 610.

In some applications, it may be advantageous to dry the chip before, or possibly after, the chip is exposed to the sample. As shown in FIG. 6, a nitrogen source 650 may be connected to one of the input ports of the chip through a configuration as shown that includes a pressure regulator 652, a mechanical pressure gauge 654, a nitrogen purge valve 656 and a nitrogen check valve 655. The system may further include a pressure sensor 658. The nitrogen may then be introduced into the system in which isolation valve 152, and one or both waste valves (602, 604) are opened permitting the nitrogen to flow through the chip and out into the waste reservoir. The nitrogen check valve prevents fluid from entering the nitrogen tank. In another implementation, another inert gas source may be used in place of the nitrogen source.

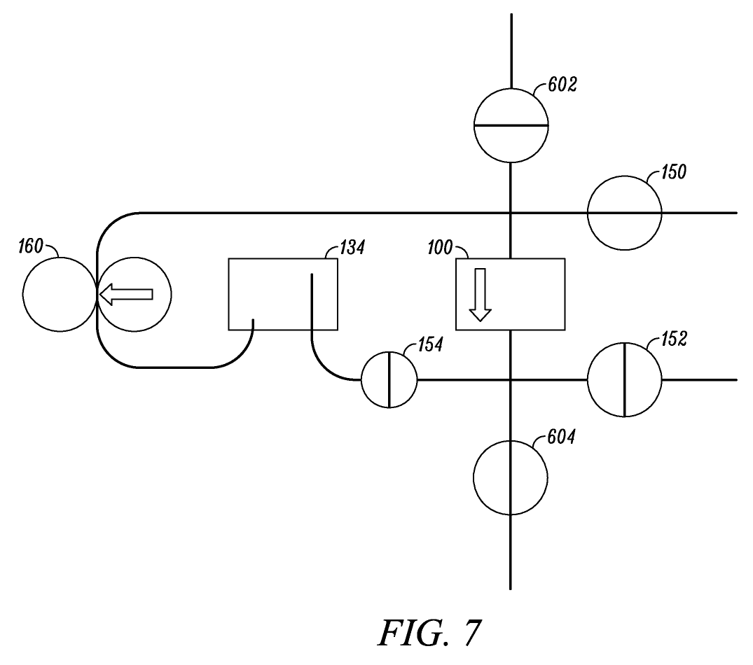

The direction of flow, as well as the specific fluid path of the fluid system may be implemented in various fashions. As discussed above, the system valves and pumps control both the direction of flow and the particular path of fluid flow. For example as shown in FIG. 7, external fluid, e.g., fluid selected by the reagent selector valve 630, may be loaded onto the chip 100. In this configuration, closing the sample valve 154 and causing the pump 160 to function as a closed valve isolates the sample reservoir from the external fluid. Thus, the sample in sample reservoir 134 is not diluted by the addition of an external reagent to the fluid system. Additionally, isolation valve 152 and sample valve 154 are closed. As the reagent is pumped into the fluid system through isolation valve A 150, the chip is primed with the reagent, and the excess reagent flows through waste valve B 604 and is deposited in the waste reservoir 610. The arrow in FIG. 7 denotes the direction of fluid flow through the chip 100.

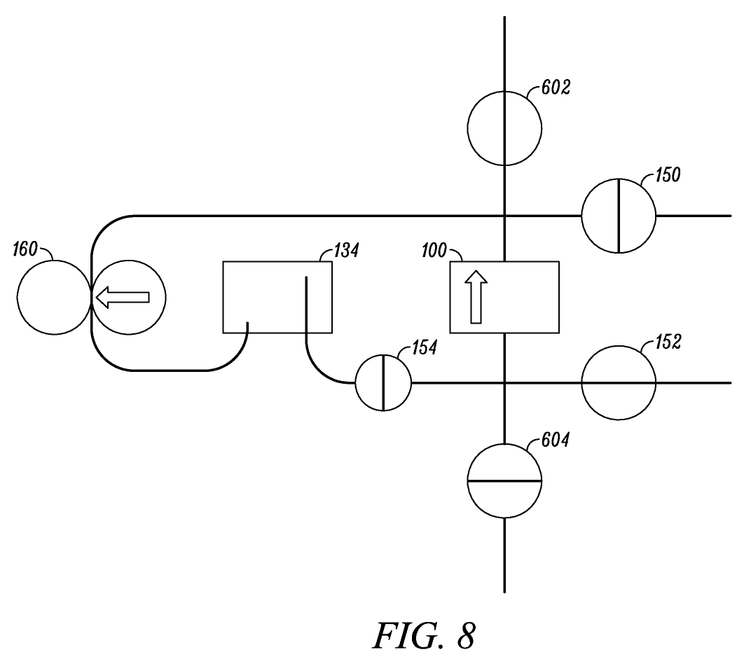

The direction of reagent flow through the chip 100 may be determined by the orientation of the isolation valves 150 and 152 and the waste valves 602 and 604 as shown in FIG. 8. In this configuration, isolation valve A 150 is closed and isolation valve B 152 is opened to permit reagent flow into the system. Additionally, waste valve B 604 is closed and waste valve A 602 is opened permitting fluid flow to the waste reservoir through waste valve A. As a reagent is introduced into the system via Port B of the reagent pump valve, reagent flows into the chip in an orientation opposite that shown in FIG. 7. Thus, the configuration of the valves in the fluidics system permits precise fluid flow control in either direction across the chip 100. The arrow in FIG. 8 denotes the direction of fluid flow through the chip 100.

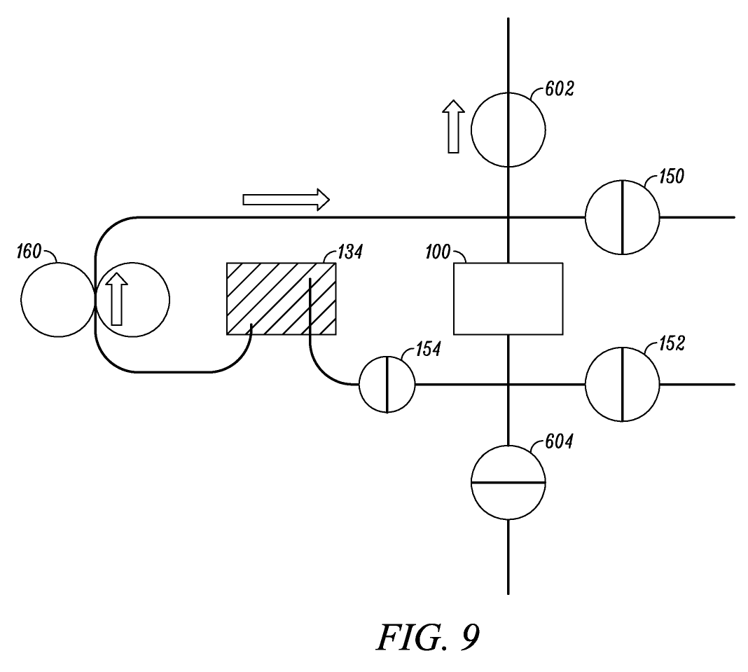

In some implementations of the hybridization station, it may be desirable to purge air from the fluid circuit. For example, FIG. 9 shows the configuration of the fluid circuit when using the sample to purge gas from conduit 120. In the implementation shown in FIG. 9, isolation valves 150 and 152, waste valve 604, and sample valve 154 are closed. Waste valve 602 is opened permitting gas and liquid to flow into the waste reservoir. The pump 160 causes the sample to move toward the waste reservoir via waste valve A 602. As the sample moves toward the waste reservoir, gas bubbles are pushed toward the waste reservoir. Consequently, gas in the pump tube 120 is removed as fluid is expelled to the waste reservoir. The directions of the arrows in FIG. 9 denote the direction of fluid and gas flow.

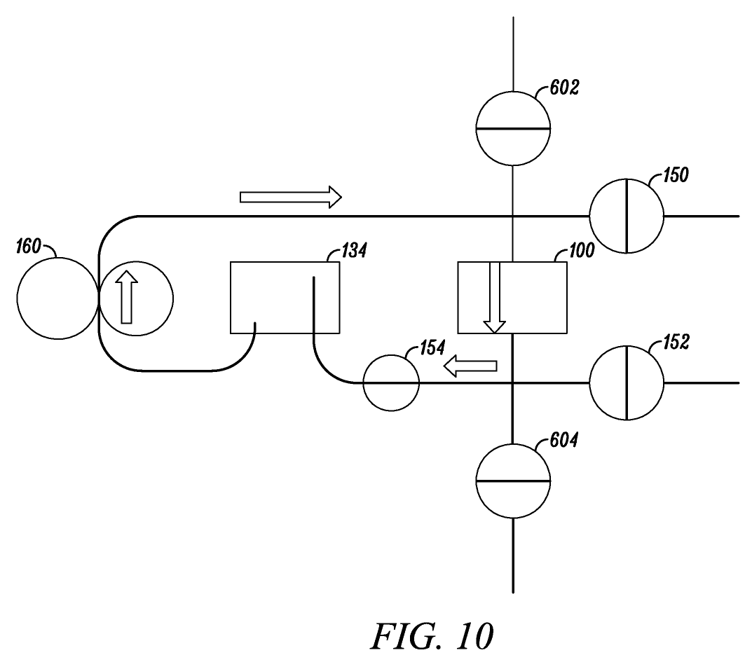

In addition to priming and purging the chip, the fluid circuit may be configured to circulate the sample through the chip 100. In the implementation shown in FIG. 10, isolation valves 150 and 152 and waste valves 602 and 604 are closed. The sample pump 160 circulates the sample through the chip 100 and sample reservoir 134. Isolation valves 150 and 152 prevent the sample from contaminating the components of the reagent delivery system such as the reagent pump 625 and valve 620, and waste valves prevent the sample from exiting the fluid system to the waste reservoir. Thus, the sample is in continuous circulation through the chip. This continuous circulation may facilitate biological assays such as hybridization, enzymatic, or chemical reactions. The directions of the arrows in FIG. 10 indicate the direction of fluid flow in the system.

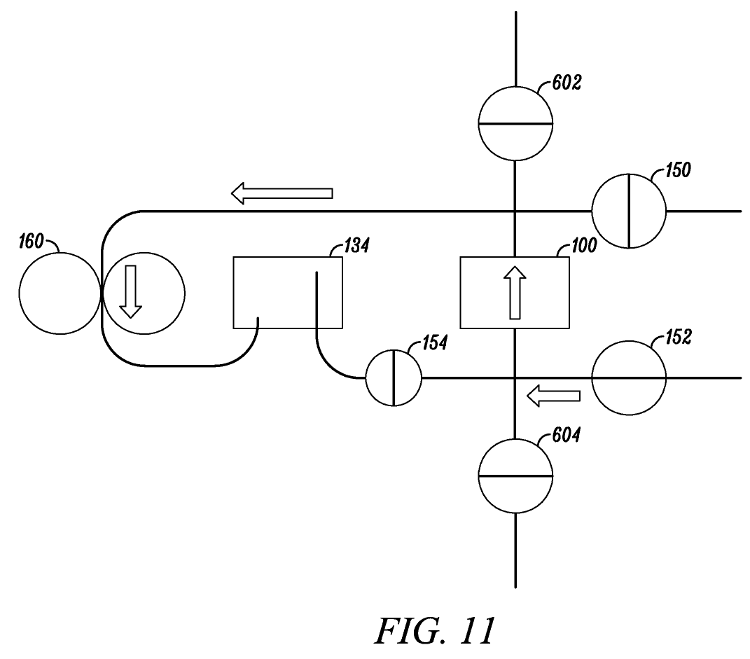

Following the interaction of the sample with the chip 100 it may be desirable to purge the sample to the sample reservoir 134 as shown in FIG. 11. In this configuration the waste valves 602 and 604 are closed to prevent fluid from entering the waste reservoir. Additionally, isolation valve 150 and sample valve 154 are closed to direct fluid flow through the chip 100 and to the sample reservoir 134. Here, the regent pump pumps reagent into the system through isolation valve 152 and into the chip 100. The sample pump 160 operates to cause fluid to flow into the sample reservoir 134. As a result, reagent flows through the chip 100 and sample and reagent flow to the sample reservoir 134. By returning the sample to the sample reservoir with the aid of a purging reagent, the concentration of sample in the sample reservoir 134 is reduced. The directions of the arrows in FIG. 11 indicate the direction of fluid flow in the system.

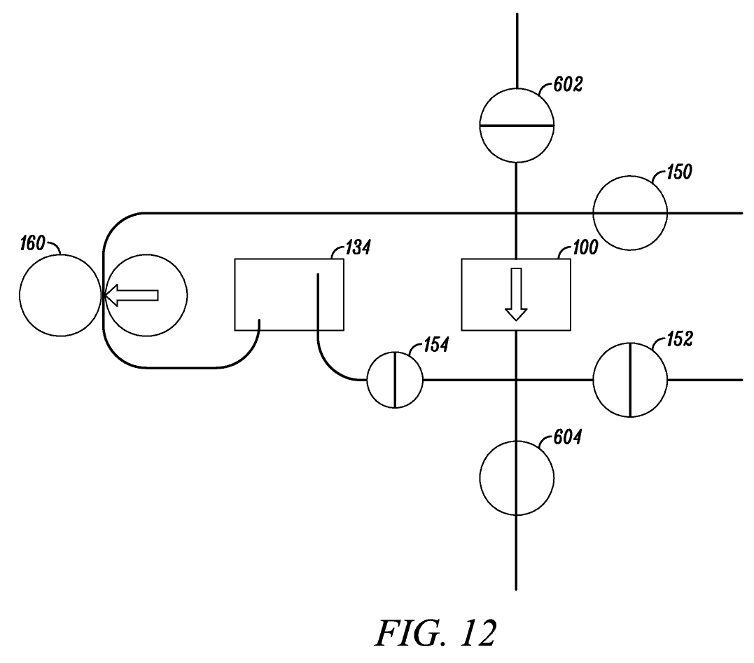

In some applications of the hybridization station it may be necessary to wash the chip 100 with particular reagents as shown in FIG. 12. The configuration of the fluid system shown in FIG. 12 is the same as that shown in FIG. 7. Here isolation valve 152, waste valve 602, sample valve 154, and sample pump 160 function as closed valves. Reagents enter the fluid system through isolation valve 150. The reagent pump pumps fluid through the chip 100, through waste valve 604, and then to the waste reservoir 610. The direction of the arrow in FIG. 12 indicates the direction of fluid flow through the system. The chip may be washed in the reverse direction by opening the isolation valve 152 and waste valve 602, and closing isolation valve 150 and waste valve 604.

The hybridization station may also include a temperature module for controlling the temperature of the chip 100. In one implementation, a thermoelectric heater/cooler module controls the heating and cooling of the chip 100. Depending on the current polarity, the module will either heat or cool the chip. A heat sink may be placed adjacent to the thermoelectric module to remove heat from the thermoelectric module. A heat pipe may thermally connect the heat sink to the thermoelectric module. In another implementation, the fluid may be heated before being added to the chip.

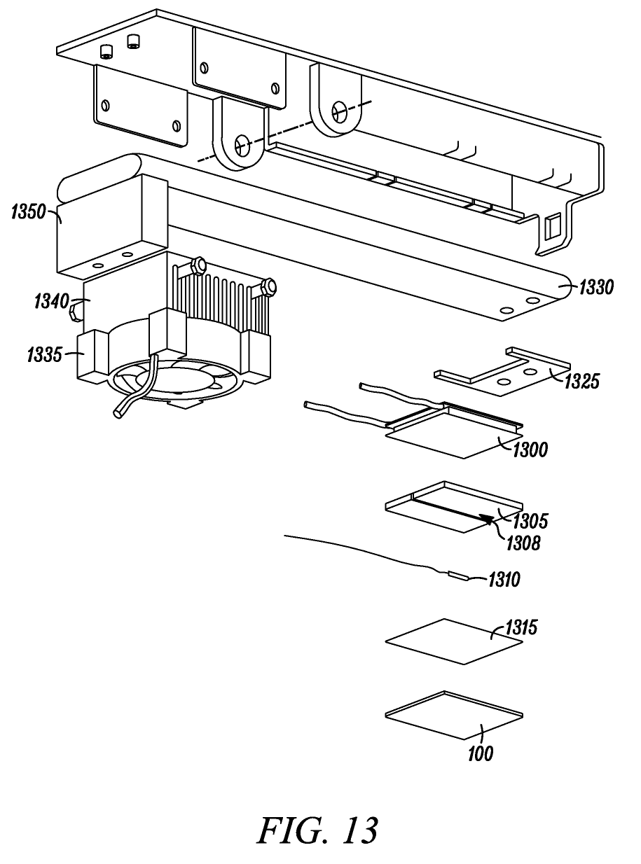

FIG. 13 illustrates one implementation of a temperature control unit of a hybridization station. A thermoelectric module may be used to heat or cool the chip 100. For example, thermoelectric module TM-127-1.0-3.9M from Advanced Thermoelectric (Nashua, N.H.) may be chosen for the thermoelectric module 1300. A copper thermistor capture plate 1305 is attached to the thermoelectric module 1300. A thermal conductive polymer 1315 is coupled to the copper thermistor capture plate 1305. The copper thermistor capture plate 1305 and the thermal conductive polymer 1315 create a thermal connection from the thermoelectric module 1300 to the chip 100. The copper thermistor capture plate includes a groove 1308. A thermistor is placed in groove 1308 to monitor the temperature of the chip 100. A heat sink 1340 with a cooling fan 1335 may dissipate the heat generated by the thermoelectric module 1300. A heat pipe 1330 may thermally couple the thermoelectric module 1300 to the heat sink 1340 and cooling fan 1335. In one implementation the heat pipe is a copper channel with an air core that is approximately 0.25 inches in width. The heat pipe 1330 may be filled with methane gas. Other types of gas may be used depending on the desired temperature range for the thermoelectric module 1300. A spacer 1325 connects the thermoelectric module 1300 to the heat pipe 1330. The heat pipe 1330 is attached to the pivot arm 1350.

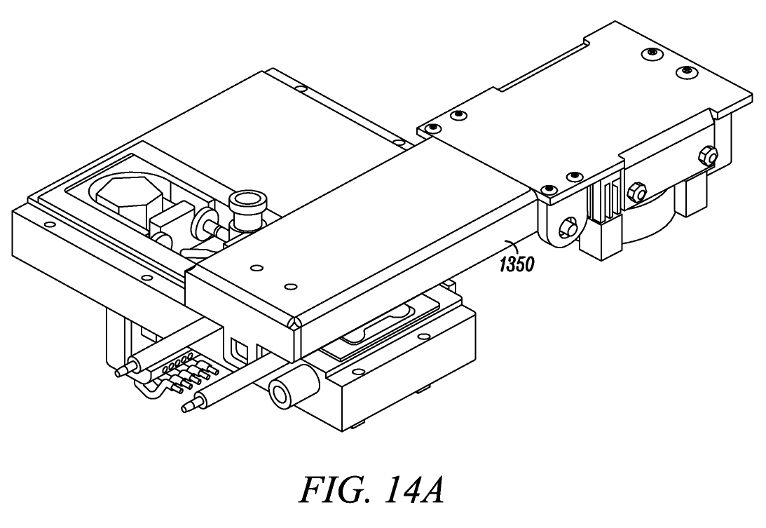

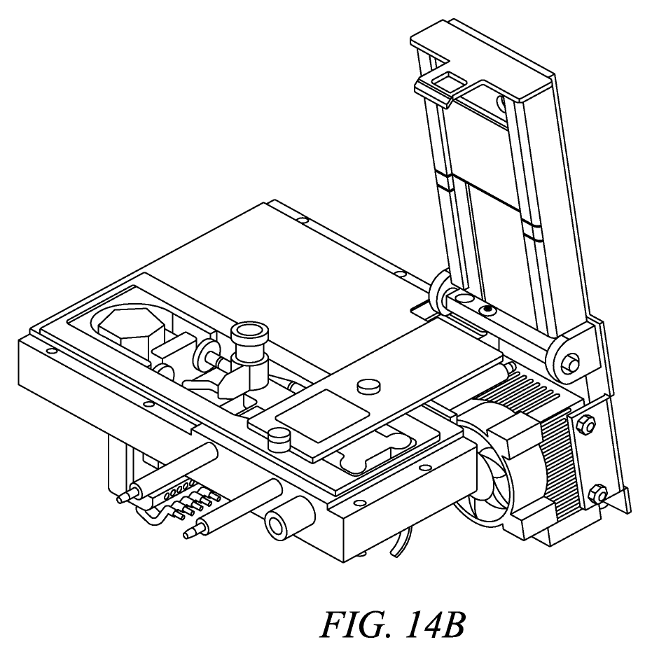

The temperature control unit may be attached to a hybridization station via a pivot arm as shown in FIGS. 14A and 14B. During operation of the temperature control unit the pivot arm contacts the chip 100 as shown in FIG. 14A. The pivot arm may be released and rotated away from the chip 100 as shown in FIG. 14B to permit access to the chip 100.

Pinch Tube Pump

High-density arrays of biopolymers (nucleic acid oligomers, peptides, oligosaccharides, and hybrids of these molecules), or biochips require a very small amount of target molecules for hybridization. However, in order to acquire good hybridization results, sample concentration should not be too low. A well-designed hybridization station should have an internal volume as small as possible to fully utilize precious bio-samples. Since lateral dimensions of biochips are typically in 1-cm² range, in order to reduce internal volume, the vertical dimension of a hybridization chamber for biochips may be much smaller than its lateral dimensions. As a result, it is advantageous to agitate target molecules for better mixing using a micro pump or other devices. One potential problem associated with using a pump to agitate the solution is the increase in volume of the system. If a micro pump is used for sample mixing, the internal volume of the pump becomes part of the internal volume of the hybridization stage. Therefore, certain hybridization systems may have a micro pump with a very small internal volume. Some commercially available pumps may have an internal volume of 20 μL. It is also preferable to have connection tubing with a very small internal diameter. Preferably the tubing should be made of polymeric material for better compatibility with DNA or other bio-samples. The smallest internal diameter of commercially available polymeric tubing is about 0.01″, although some tubing is available with an internal diameter less than 0.01″ for certain materials. Unfortunately, this tubing is incompatible with most commercially available pumps, which have ports of I.D. larger than 0.01″. The present disclosure addresses this potential disadvantage by providing a pump in which small internal diameter tubing serves as the pump body with all the movable parts outside the tubing. This provides for a hybridization system with an internal volume of ˜50 μL or less.

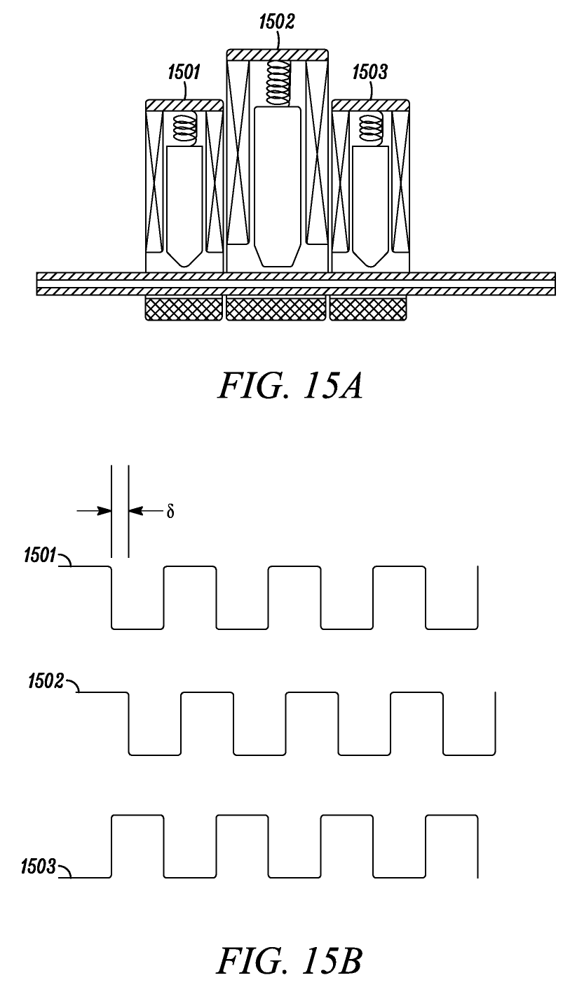

A tube pinch valve pushes fluid both directions in the tube when it pinches the tube, i.e., closes the liquid passage at the pinch point. However, either the inlet our outlet is sealed when the valve operates, the direction of fluid flow may be controlled. Scaling or opening the inlet or outlets can be implemented by pinch valves as well. So if three pinch valves 1501, 1502, and 1503 are lined up along a piece of flexible tubing and are driven in a timing sequence as described in FIG. 15A, they continuously deliver liquid from one end of the tube to the other.

In one embodiment, silicone tubing with 0.010″ I.D. and 3/32″ O.D. is used as the pump tube. In principle, the internal diameter for the pumping tube should be as small as possible in order to reduce internal volume of the pump. However, 0.010″ is the smallest I.D. commercially available for silicone tubing at present. The thick wall of said silicone tubing can provide fast recovery of deformation and a long lifetime. The recovery time of the pump tube limits the maximum driving frequency thus limiting the maximum pumping rate for the pump for a given pump tube.

Solenoid driven pinch valves provide one cost effective choice for the pinch mechanism. These pinch valves can be purchased from venders such as Bio-chem Valves, Inc. In a preferred embodiment, Bio-chem Valve 075P2-PP473 was chosen for valves 1501 and 1503 as shown in FIG. 15A. This product is the smallest pinch valve supplied by Bio-chem Valves, Inc. It has a cylindrical shape with a diameter of 0.75″. Since the pump tube is usually used as connection tubing as well, the internal volume of such a pump is defined as the volume of fluid inside the passage from the left edge of valve 1501 to the right edge of valve 1503 in FIG. 15A. Using pinch valves with smaller diameter may reduce the internal volume of the pump by shortening the tubing length from the left edge of valve 1501 to the right edge of valve 1503. Additionally, 075P2-PP473 consumes less power than other pinch valves supplied by Bio-chem Valves, Inc. In a preferred embodiment, valve 1502 in FIG. 15A is a custom made pinch valve. This custom valve has a cylindrical shape with a diameter of 1″. Unlike a conventional pinch valve, which has a chisel-like plunger, this valve has a cylindrical plunger with a diameter of 0.5″. The flat pinch head provides a larger dispensing volume than a sharp one. Since the driving frequency is limited by the recovery time of the pump tube, increasing dispensing volume can increase the maximum pumping rate, which is desirable for some applications.

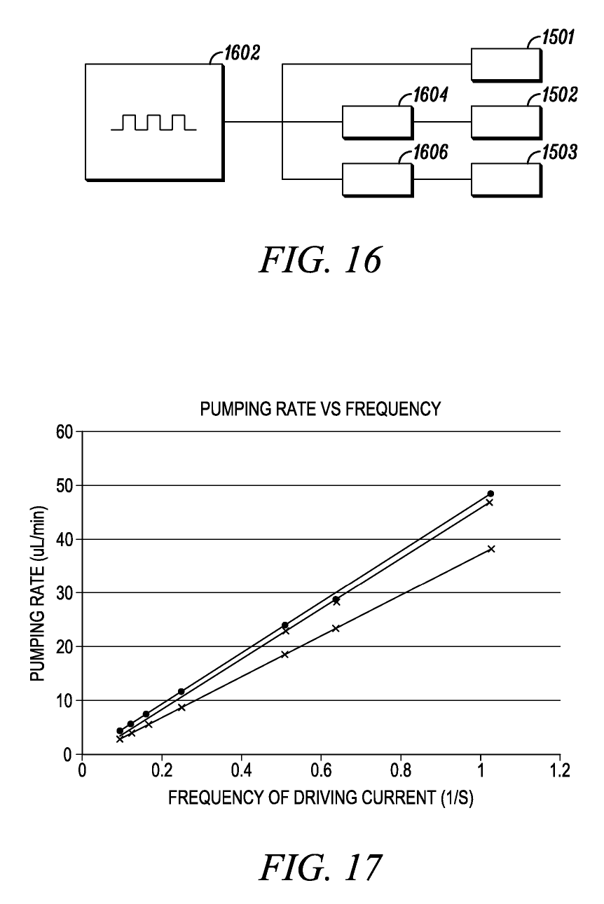

The driving circuit shown in FIG. 16 includes an element to generate cyclic pulses, i.e., a clock signal generator 1602. In a preferred embodiment, the clock signal is of rectangular form. The driving circuit includes another part that shifts the phase of the original clock signal for each individual circuit valve. In another embodiment, an Omron H3CA-A time relay set to B mode, which can be purchased from McMaster-Carr, is used to generate the clock signal. An RC circuit 1604 may be used to shift the phase of about 0.1 sec for Valve 1502 in FIG. 15, and may include a 180° phase shifter circuit 1606 connected to valve 1503. The circuit has some switches, not shown in FIG. 16, to bypass all the valves to OPEN position so that the pump tube functions just like a connection tube. In this way, an external pump or other device such as a syringe can flush the system via the pump tube with a much higher flow rate. Also not shown in the figures is a DPDT switch to swap the hot wires connecting to Valve 1501 and 1503 so that direction of liquid movement can be controlled.

With the above described embodiment, the pump was tested in the following way:

1. Self Priming
The inlet of the tube pinching micro pump was dipped in D.I. water, and the outlet was suspended in air. After the pump was started, the water/air interface in the silicone tube moved about same distance for each pump cycle. The silicone tube was fully filled with water soon after a water droplet appeared at the outlet. Thus, the pump is capable of self-priming.

2. Gas Pumping
The outlet of the tube pinching micro pump was dipped in D.I. water, and the inlet was suspended in air. After the pump was started, an air bubble appeared at the outlet. The bubble grew after each pump cycle until the buoyant force overcame the surface tension and pushed the bubble out of water. Then another bubble appeared, grew and surfaced. The cycles kept going until the pump was stopped. The gas pumping property makes the pump suitable for applications that require delivery or dispensing of gas in a very small volume.

3. Pumping Rate Versus Driving Frequency
An ACCULab LA-200 balance was used to weigh D.I. water delivered by the pump. From the weight the volume of fluid delivered in a certain period of time and thus the pumping rate were calculated. For different driving frequencies, the total pumping cycles were set to the same, which was 120, to ensure <1% error that may be caused by one incomplete cycle. The evaporation rate was calculated by measuring weight difference of water in a container for a certain time interval. The linearity of the pump rate versus driving frequency is excellent (r>0.999), which demonstrates that each pump cycle delivers same amount of fluid. One essential factor for this digital pumping behavior might be the thick wall of the silicone tube used in the experiment, which enables fast recovery of its shape after pinch deformation.

The theoretical curve is calculated based on the following assumptions: 1. The silicone tube is of uniform I.D. (0.01″ in diameter); 2. The flat plunger is of 0.5″ in diameter; 3. Each cycle delivers same amount of fluid in the Φ0.01″×0.5″ cylinder.

A graph showing an example of data for the pumping rate versus frequency is shown in FIG. 17. In the figure, the x points are the measured data, the filled circles are corrected data and the filled diamonds are the theoretical points. The theoretical value is smaller that the experimental results. This may be due to a number of factors. It is possible that the tube I.D. is not uniform or actually bigger than the value specified by the manufacturer. However, the discrepancy is more likely due to the fact that the sharp plungers in Valve 1501 and 1503 contribute to the pump rate due to phase delay of valve 1502. Consider valve 1501, when it closes the liquid passage, it pushes liquid to both ends since Valve 1503 opens at the same moment and Valve 1502 is open for a short time, say 0.1 sec. When Valve 1501 opens, it pulls in more liquid from inlet since Valve 1502 stays in a closed position for a short time. Consider Valve 1503, when it opens the liquid passage, it pulls liquid from both ends since Valve 1501 closes at the same moment and Valve 1502 is open for a short time. When Valve 1503 closes the liquid passage, it pushes more liquid to the outlet since Valve 1502 stays in closed position for a short time. Based on the discussion above, about half of the volume under the plungers of valve 1501 and 1503 (assume they are of the same size) will contribute to the pumping rate in addition to the volume under plunger of valve 1502.

Tubing Selection

The preferred tubing to be used in a pinch valve may be flexible or elastically deformable, or “pinch-able”. Silicone is widely used for pinch valves. It has good chemical resistance and is compatible to bio-samples. Other candidates for the pump tube are Tygon®, Viton® and other elastomer materials used for peristaltic pumps. For a specific pinch valve, the tubing size is also limited by the power of the pinch mechanism.

The tubing used for the pinch valves preferably interfaces with the pump. Further, tubing with thicker walls may be selected since it is not necessary to ensure the pinch valves to fully close the liquid passage. As discussed earlier, the pump effect is created by the fact that a pinch valve can push or pull more liquid from one end than the other if one end is sealed. A more general discussion would be a pinch valve could push or pull more liquid from one end than the other if one end has higher resistance than the other. If Valve 1502 in FIG. 15 cannot fully pinch off the liquid passage, the only side effect is less dispensing volume or lower pumping rate. If Valve 1501 or 1503 or both cannot fully pinch off, the liquid passage, there will be some backflow in a pumping cycle but as long as the pinching action creates enough resistance difference, the valve assembly will still act as a pump with a lower pumping rate. This effect is known as internal leak. The situation is the same as a diaphragm pump with check valves not sealing well.

The above discussion provides a wider choice of tubing material. For example, metal or other hard tubing with thin walls that are seldom used for peristaltic pumps may be suitable for the tube-pinching pump. A thin wall ultra micro bore Teflon® tubing, which is available from Perkin-Elmer, was tested as the pump tube. The pump ran for a short period of time before the tube was plastically deformed. Thin wall metal tubing like stainless steel or copper might could be used in other implementations.

For dependability and long lifetime, it is necessary to use silicone or other elastomer tubing. However, chemical resistance of elastomers is not as good as Teflon®. A preferred embodiment would be an elastomer tubing with a Teflon® liner.

Pinch Mechanism Selection

Generally speaking, any device that can deform and release the pump tube at a fixed point can be used for the pinch mechanism. In addition to the solenoid mechanism described above, piezoelectric devices can be suitable for pinch mechanisms. For hard tubing or soft tubing with thick walls, it may be desirable to use pneumatic devices and step motors to provide a strong pinch force. A piston driven by a rock arm, as used in an automotive engine, can also be used as the pinch mechanism.

Driving Circuit

Besides the commercial time relay mentioned above, there are many alternatives for generating a clock signal. For example, many oscillator circuits could serve this purpose. Comparing to time relays, it may be necessary to use a transistor or relay to supply enough current. The amount of current may depend on the power consumption of the pinch mechanism. In another implementation, a wave function generator may be used as clock signal for convenience. Further, the waveform need not be rectangular.

The nature of the pulsed or digital motion of the valve assembly makes it easy to control with a computer. For example, a digital I/O board such as PC-DIO-24 supplied by National Instruments can be used to provide clock signals. With each pinch valve connected to one I/O channel via a transistor or relay, the computer can generate a clock signal for each individual valve at any phase and any desired ON/OFF ratio. This makes control of the pump even more flexible. For example, since each pump cycle delivers about same volume of liquid, the computer can operate the valve assembly to certain cycles to deliver liquid of a pre-set volume and then stop it or even reverse the pumping direction. It is also easy to generate clock signals to pump one cycle forward and one cycle backward to use the pump as a percolation pump instead of a circulation pump.

Pinch Head (Plunger) Shape

Conventional pinch valves have a chisel-shape pinch head. In a preferred embodiment, a custom made flat pinch head is used for valve 1502 to create a higher maximum pumping rate for certain applications. However, valve 1502 can be a conventional pinch valve with a chisel-shape pinch head. It is an aspect of the disclosure that the shape of the pinch head, or in effect, the size of the contact area with the tubing may be manipulated to affect the maximum pumping rate. The use of any shape or size of pinch head is contemplated and falls within the scope of the disclosure.

Number of Valves

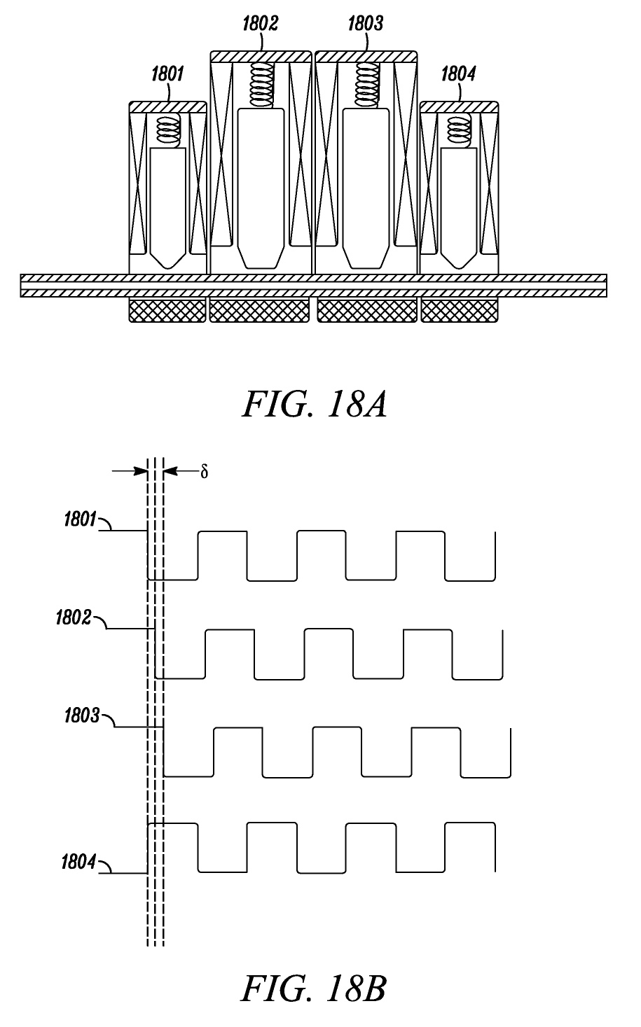

In a preferred embodiment, three pinch valves form a pump. The number of pinch valves is not limiting. In other implementations, four or more valves in series may be used as well. The embodiment shown in FIG. 18 is an example of a valve assembly with four valves. Valve 1801 and 1804 are Bio-Chem Valves 07SP2-PP432, while Valve 1802 and 1803 are Bio-Chem Valves 100P2-PP473, which are custom made for the present disclosure. The clock driving Valve 1802 has a small phase delay relative to Valve 1801, and the driving clock for Valve 1803 has a phase delay relative to Valve 1802. Valve 1801 and 1804 are operated in opposite phases, i.e., 180° phase difference.

There are two advantages for a pump with four or more valves compared to the three-valve pump. First, it can have a larger dispensing volume if the assembly operates with the timing sequence described in FIG. 18. The other advantage is that it can have different dispensing volumes if it bypasses some of the central valves during operation. For example a four-valve assembly can be used as a three-valve pump or a four-valve pump as needed.

Arrangement of Valves

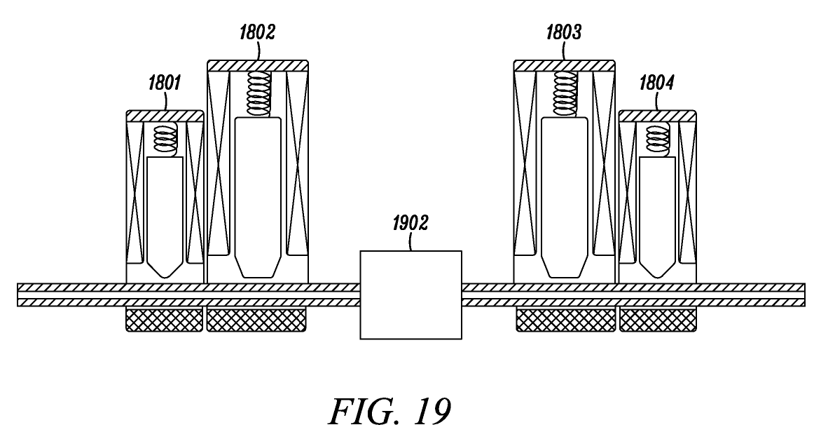

Unlike other pumps, the tube-pinching pump does not have to have all the parts next to each other, let alone tightly packed. Each valve can be placed anywhere along the liquid passage. For example it can have a chemical reactor 1902 between the valves, see FIG. 19. With such arrangement and computer control, we can use the pump as a three-valve or four-vale circulation pump, or use it as a percolation pump with valve 1801 and 1804 closed. One advantage for tube-pinching pumps is that if the connection tubing is silicone or other elastomer, such a tube-pinching pump can be added to or removed from the system at any time without breaking any seal of the liquid passage.

Two kinds of pumps employ a flexible tube in the pump body. One is a special micro diaphragm pump designated for implantation into a human body, described in U.S. Pat. No. 4,344,743. It uses a flexible tube inside a liquid filled chamber for better volume control. Another kind is the classical peristaltic pump. A typical peristaltic pump mainly has a rotor with multiple notches that continuously press a flexible tube causing peristaltic motion of the liquid inside the tube. One advantage for peristaltic pumps is that it has all the moving parts outside the fluid passage.

The disclosed pump is easy to maintain. The tube is easily replaced by placing all the plungers in the “up” or open position. Any bad solenoid can also be replaced easily, although a typical solenoid pinch valve has a lifetime of 1 million cycles.

Compared to the micro pump described in U.S. Pat. No. 4,344,743, the pumps disclosed herein are simpler in structure and have all the moving parts outside fluid passage. In addition, the pinch valve pump is free from sealing problems since the whole liquid passage inside the pump plus connection tubing to other components is one seamless tube. The disclosed pump is dependable for operation and resistible to contamination and leakage. Another advantage is that the pumps may be added or removed from the system without breaking any seal.

Compared to peristaltic pumps, the disclosed pumps are more compact and may provide digital pumping control that can deliver a preset volume controlled by computer. The mechanical tolerance required to assemble the pinch valves with a flexible tube to form a pump is of very low stringency. It is also easy for a tube-pinching pump to leave the fluid passage fully open for flushing. This is important for a chip cartridge with multiple parallel channels and narrow gaps, which may require a high flow rate to flush out any trapped air. An example is the micro fluidic chip, for example, as described in U.S. Pat. No. 5,953,469 or WO 02/02227 A2 where many cells are connected to the same inlet and outlet, and the depth of the cells is only tens of microns.

A micro pump with an internal volume as small as 3 μL can be used in many applications wherever small internal volume is important. A large market is emerging for hybridization stages with very small internal volume of a few hundred μL to less than 100 μL for biochips. For example, the disclosed pump is adaptable to the hybridization stage marketed by Affyretrix, and is able to perform their preferred “drain and fill” fluid mixing method. The capability of pumping fluid and gas forward and backward with a pseudo digital volume control makes the pump suitable for sample dispensing as well.

6-Port Two Position Rotary Valve for Controlling Fluidic Loops

In order to carry out hybridization in a microfluidic chip, it may be necessary to prime the chip so that no air bubble will block any cells or channels during hybridization. This requires a high flow rate and high pressure. A syringe pump may be used for this purpose. On the other hand, hybridization assays require low internal volume to avoid diluting the sample below the detection threshold for a hybridization detection system. A peristaltic pump with a silicone tube of very small ID may meet this requirement. Additionally, many implementations of valves may be used to control fluid flow. However, the burst pressure of silicone tubing is low relative to pressure the a syringe pump can deliver. It may be preferable to avoid silicone tubing in the fluid path for which fluid is delivered by the syringe pump. In one embodiment, a commercial 6-port 2-position rotary valve may be used as described below. A preferred valve is commercially available and is manufactured by Valco, Rheodyne.

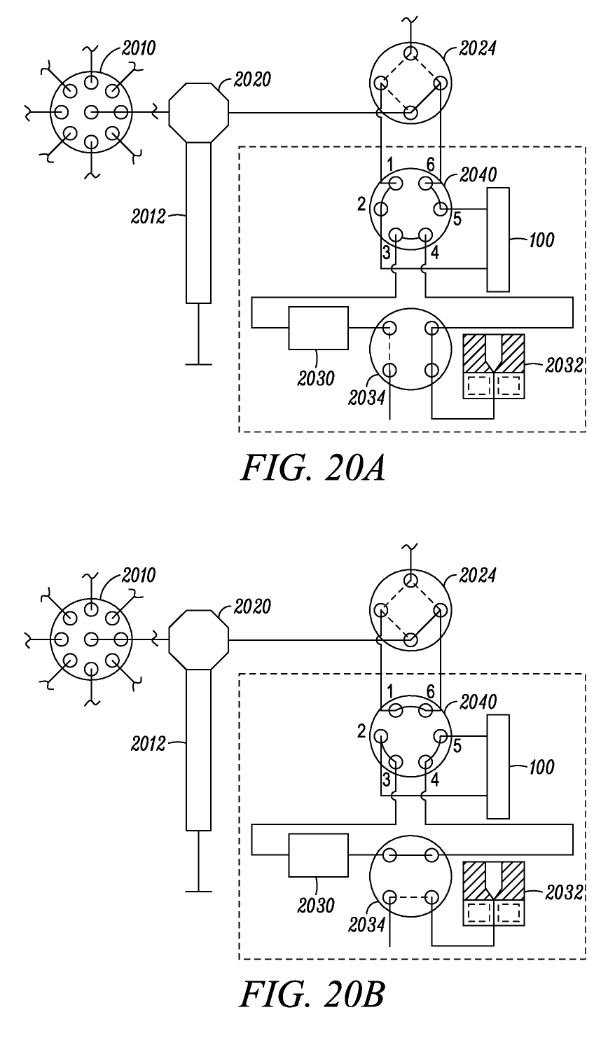

FIGS. 20A and 20B are diagram of one implementation of a fluid circuit of a hybridization system. Here no temperature control elements are shown. A multi-position valve 2010 is connected to several reservoirs containing buffer or other chemical reagents. The common port of the multi-position valve is connected to a syringe pump 2012 that has a three-way valve 2020 attached to it. The syringe pump can draw fluid from any reservoir connected to the multi-position valve's input port, and deliver the fluid through the three-way valve to a selected output port. Additionally, a 4-port 2-position valve 2024 may be connected to the output of the syringe pump. This 4 port 2 position valve 2024 can reverse the flow direction in the microfluidic chip by switching positions. The multi-position valve 2010, syringe pump 2012, and the 4-port 2-position valve 2024 form a priming/washing unit.

A sample pump 2030, such as a peristaltic pump, plus a sample reservoir 2032 forms the sample delivery/agitation unit. An optional 4-port 2-position valve 2034 is used to close the sample loop after the sample has been drawn into the microfluidic chip from the sample reservoir.

In one implementation, the microfluidic chip is connected to one pair of diagonal ports on the 6-port 2-position valve 2040, for example, ports 2 and 5. Both priming/washing and sample delivery/agitation units are connected to each pair of adjacent ports separately.

In step 1, simultaneous priming of the chip and sample loop, shown in FIG. 20A, the 6-port 2-position valve 2040 is at one position, for example, position A. The fluid delivered by the syringe pump travels through the 4-port 2-position valve, into port 1, out of port 2, through the microfluidic chip 100, into port 5, out of port 6, and back to the 4-port valve 2024 to waste. Meanwhile, the sample pump 2030 can prime the sample path by drawing fluid from the reservoir 2032, delivering it into port 4, out of port 3, and to the waste reservoir.

In step 2, recirculation of sample through the chip, shown in FIG. 20B, the 6-port 2-position valve 2040 is at the other position, B for example. The sample delivered by the sample pump 2030 goes into port 4, out of port 5, through microfluidic chip 100, into port 2, out of port 3, and back to sample reservoir 2032, or one may use a 4-port 2-position valve to close the loop. Meanwhile, the syringe pump 2012 can prime or wash the priming/washing unit by drawing fluid from reagent reservoir, delivering it into port 1, out of port 6, to waste.

### OTHER EMBODIMENTS

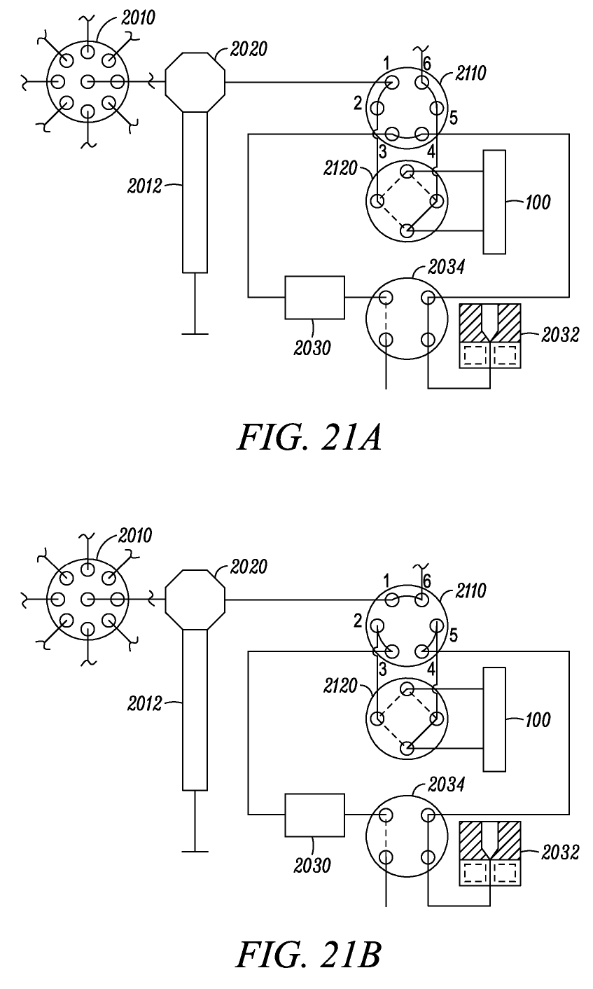

FIGS. 21A and 21B show another embodiment. In this implementation, the 4-port 2-position valve 2120 to reverse flow is connected directly to the chip, and the 6 port-2 position valve 2110 is connected to the pump 2012, so that bidirectional percolation is possible. Not all pumps can operate in a bidirectional mode. In the embodiments shown in FIGS. 21A and 21B, the total volume of the sample path excluding the rigid tubing may be about 24.5 μl.

Advantages

1. The sample loop and priming/washing loop never crosstalk, so that these two loops can have different pressures and there is no danger of bursting a soft tube material, such as silicone when using a peristaltic pump;

2. 6-port 2-position rotary valve has zero dead volume, while other methods, such as using a Tee plus two diaphragm valves, can easily introduce dead volume in fluid loops.

3. Priming of sample loop and priming/washing loop can be carried out separately so that no air bubbles are introduced while switching the 6-port valve. For example, the hybridization unit including the 6-port valve can be detached after the chip is primed, and re-connected after hybridization for washing with the syringe pump without introducing air bubbles to the chip. Preferably, the priming/washing unit should be primed before the 6-port valve back is switched to position A.

In certain embodiments, a hybridization station as disclosed herein may be configured for real-time study of hybridization and other biological/chemical reactions in a microfluidic chip that is composed of a substrate and a transparent window. The fluid loop for circulating fluid through the chip includes conduits connecting the sample reservoir and a pump. The chip is in contact with a heat conductor, which conducts heat between the chip and a thermoelectric module, so that the temperature of the chip is controlled. Fluorescence is used to monitor the hybridization and/or biological/chemical reaction. The fluorescence from inside the chip is excited by light through the transparent cover and is preferably detected by a cooled CCD camera illuminated through a lens and a filter system.

In the real time hybridization embodiment, the chip is a microfluidic device, and thus, solution in each reaction chamber can be continuously circulated, i.e., hybridization can be performed under flow conditions. This should facilitate mixing during the hybridization, if a sufficient amount of target sequences are present in solution. A preferred hybridization station may include at least five modules: A) a circulation pump B) a cooled CCD camera with color filters mounted for selection of detection wavelength (Apogee Instruments C) a light source (200 W Xe/Hg lamp and controls; Oriel), D) a computer controlled Peltier heating/cooling plate (Torrey Pines Scientific); and E) the chip in a heat-insulated cartridge with an aluminum block between the cartridge and the Peltier plate. The pump and the chip are connected through Teflon tubing.

The hybridization stations of the present disclosure may accommodate a single chip, or they may be configured to accommodate 2, 4, 6, 8 or more chips for simultaneous and independent reaction and analysis. Examples of such embodiments are described below.

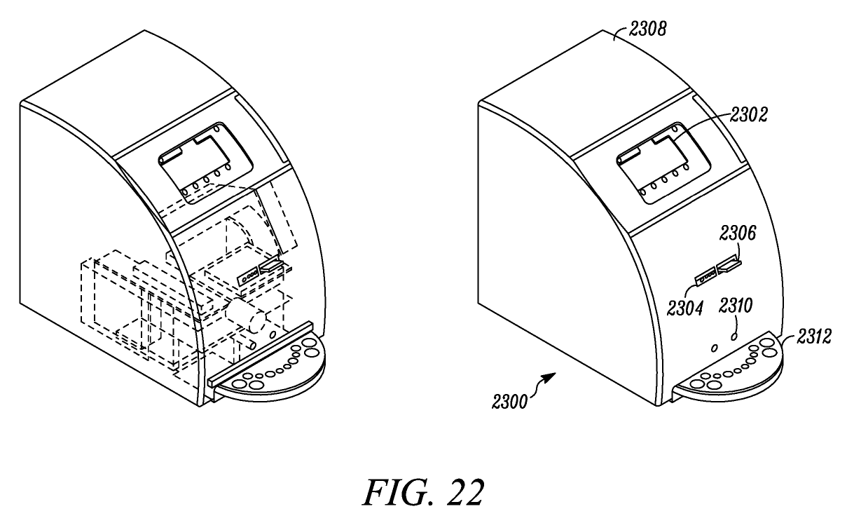

An embodiment of the disclosure is a hybridization station 2300 designed to process two chips simultaneously, shown in FIG. 22. As shown in FIG. 22, the system includes a housing 2308, a user interface 2302, openings 2304 to receive two chip cartridges 2306, inlet and outlet holes for connection of tubing 2310 and a sample holder tray 2312 with tube holders for samples, reagents, buffers and other fluids. During the use of this station, tubing is manually placed in the appropriate reservoirs by an operator. For example, during a hybridization cycle, the inlet and outlet tubes may be placed in a single reagent reservoir for circulation of the sample. Whereas during a wash cycle, the inlet tube may be placed in a reservoir of buffer or other washing fluid and the outlet tube may be placed in a waste receptacle. The user interface provides the ability to select pre-programmed cycles, or to adjust parameters such as time and temperature manually as described herein.

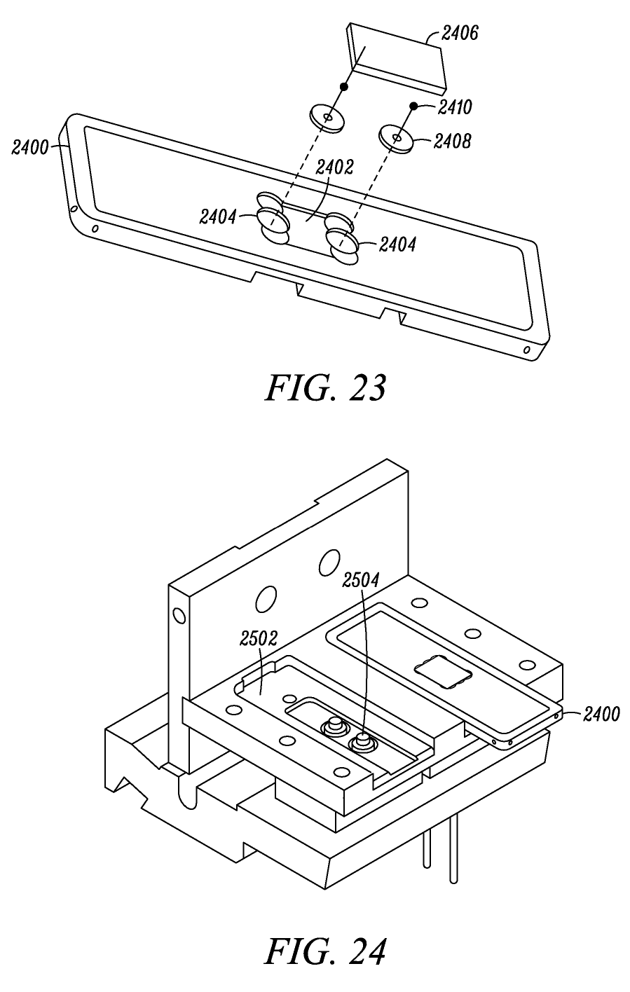

An example of a chip cartridge 2400 is shown in FIG. 23. The cartridge provides a depression 2402 that holds the biochip 2406 in place, and aligns inlet and outlet conduits 2404 in the chip with the fluid posts 2504. When placed in the cartridge, the chip inlet and outlet ports are aligned with the inlet and outlet ports of the chip cartridge so that a closed loop may be formed. When the chip is a biochip such as a silicon microfluidic chip, fluid flows into the chip inlet port and through the channels of the silicon substrate to reach the active surfaces. Fluid then flows out the outlet of the chip and chip cartridge to complete the loop, or to remove waste fluid. It is understood that the inlet and outlets are interchangeable and that fluid may flow in either direction, or alternately in both directions during use of a biochip in the described chip cartridge. The chip cartridge also provides gaskets 2408 that flatten to seal the inlet and outlet connections during use. In preferred embodiments, a frit filter 2410 is embedded in the gasket 2408 to remove impurities and improve chip function.

A part of a chip interface subassembly is shown in FIG. 24. The subassembly shown accommodates two chip cartridges. It is understood as described herein, that a hybridization or fluidics station may provide two or more of such subassemblies in a single housing, wherein each is connected to two fluid loops for the reactions and analysis of microarray or biochips. A single station or apparatus may then provide for the simultaneous and independent use of 4, 6, 8 or more chip cartridges as needed. As shown herein, all such fluid loops may share certain elements of the fluid loop such that large reagent or waste reservoirs may be accessible to each chip through a continuous system of pumps and valves. The term “fluid loop” as used herein would encompass such systems in which the entire closed fluid loop includes only a single chip cartridge or in which the loop has many branches and subloops to service multiple chips cartridges.

The chip interface subassembly provides a cartridge guide 2502 that serves to align the inlet and outlet conduits of the chip with the fluid posts 2504. Further alignment is provided by the inlet and outlet ports 2404 on the cartridge, which include a chamfered opening to guide the fluid posts into the cartridge inlet and outlet. The angle of the chamfer is preferably about 45°. In preferred embodiments, the chip interface subassembly is forced down onto the stationary or fixed fluid posts to close the fluid loops, and the subassembly is raised off the posts to disengage the chip cartridge. In preferred embodiments, the chip cartridge is forced down onto the fluid posts by a spring and the chip is disengaged by compression of the spring.

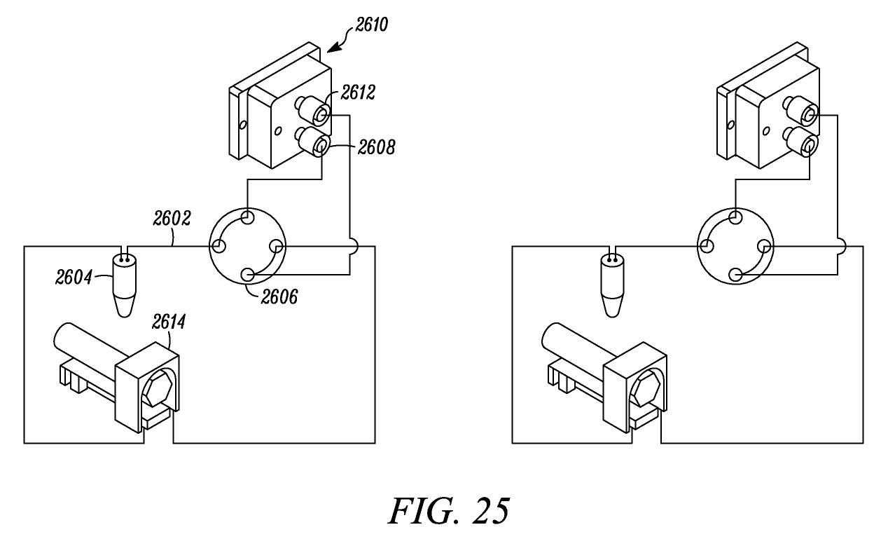

An example of a fluid loop for a hybridization station is shown in FIG. 25. In this exemplary fluid loop, tubing 2602, preferably Teflon tubing connects a reservoir 2604 to a reversing valve 2606, and connects the reversing valve 2606 to the inlet port 2608 of the chip cartridge. Tubing then connects the outlet port 2612 of the cartridge to the other side of the reversing valve 2606. Tubing then connects the reversing valve back to the reservoir 2604 for recirculation. In the embodiment shown, the fluid circuit includes a peristaltic pump 2614 configured to propel the fluid through the circuit. It is also understood that the outlet tubing may be configured to terminate in a waste reservoir or other container, rather than recirculating into the sample reservoir as shown. The reversing valve serves to reverse the direction of flow of fluid through or across the chip thus improving hybridization or other reaction efficiencies and removing air bubbles from the chip. In certain embodiments a separate pump is provided for each chip cartridge, or multiple cartridges may be served by a single pump.

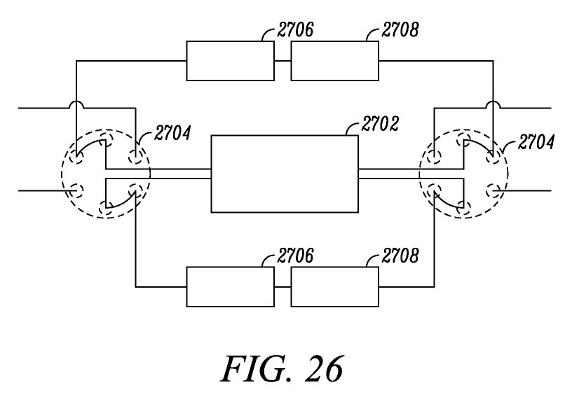

An example of a fluid circuit or loop in which a single pump serves multiple chips is shown in FIG. 26. In this circuit, a pump 2702 is connected to two three-way valves 2701, which are in turn connected to separate reservoirs 2706 and to the chips 2708. The tubing then returns to the three-way valves to complete the circuits. Although the embodiment shown would serve two chips, it is understood that, in light of the present disclosure, one in the art could connect a plurality of such circuits to a master module for fluid and circuit selection to obtain a high throughput station for multiple chips.

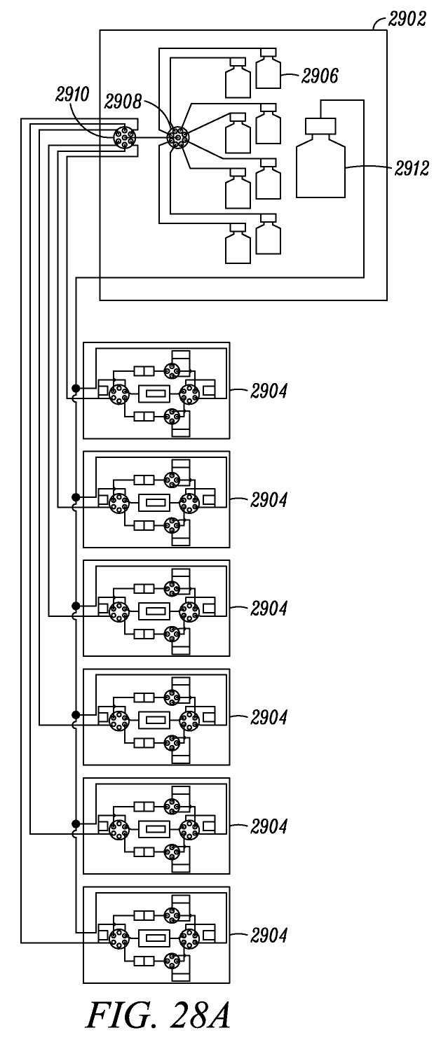

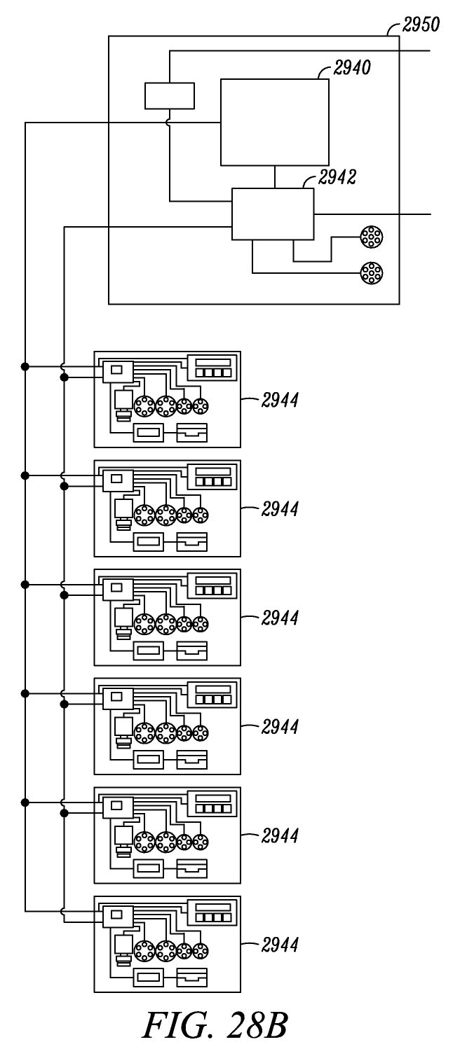

An example of a high throughput system is shown in FIG. 28A. In the fluid schematic, a master control module 2902 is in fluid communication with a series of slave modules 2904. The master control module 2902 includes reservoirs or bottles 2906 for reagents, buffers, water, samples, or any other liquid or solution required by a user. Each reservoir 2906 is connected to a single port in a multiport valve 2908 so that the computer can select individual agents to be delivered to a second multiport valve 2910 to which each slave module is connected. Also shown in the master control module is a waste bottle 2912 that is connected to all the slave modules to provide a common waste receptacle. A control schematic is shown in FIG. 28B, in which the master control module 2950 includes the user interface 2940 connected to the main PLC 2942, which is networked with the individual slave module control systems 2944.

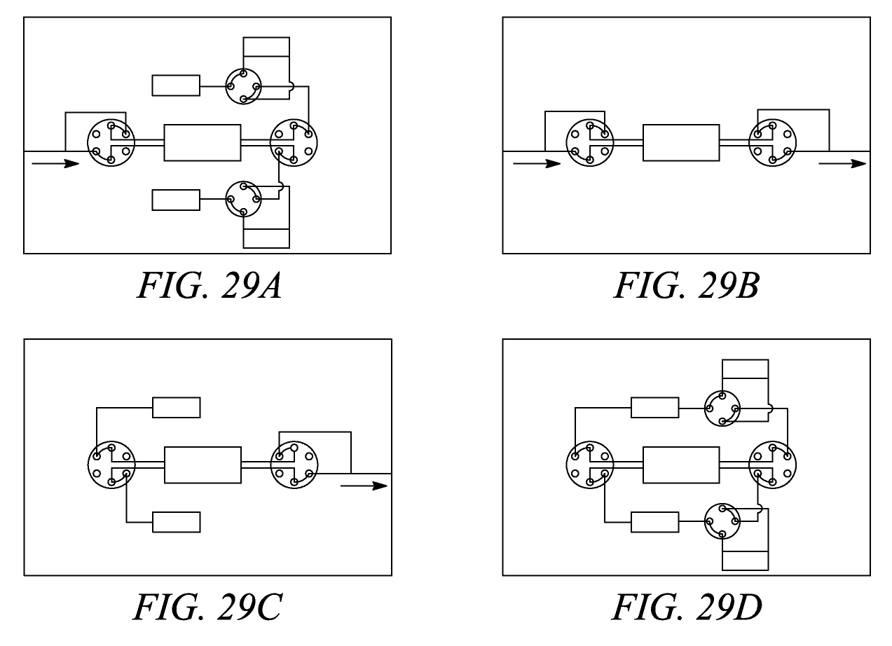

Examples of slave module flow configurations are shown in FIG. 29A-D. FIG. 29A is an example of a configuration used to fill one or more reservoirs. In this embodiment, fluid from the master module, or from an outside source enters through the 3-way valve and is propelled by a peristaltic pump to another 3-way valve, which directs fluid to the two reservoirs. FIG. 29B is an example of a configuration used to flow liquid through the module, in which liquid enters through a first 3-way valve and is pumped by the peristaltic pump out through a second 3-way valve. FIG. 29C is an example of a configuration used to empty reservoirs, in which fluid in the reservoirs is pumped through first a first 3-way valve and then exits through a second 3-way valve. FIG. 29D is an example of a configuration to recirculate fluid within a module in which two subloops, each comprising a reservoir, a reversing valve and a chip, each utilize a common pump and pair of 3-way valves to recirculate fluid within each subloop without mixing of the contents of the two loops.

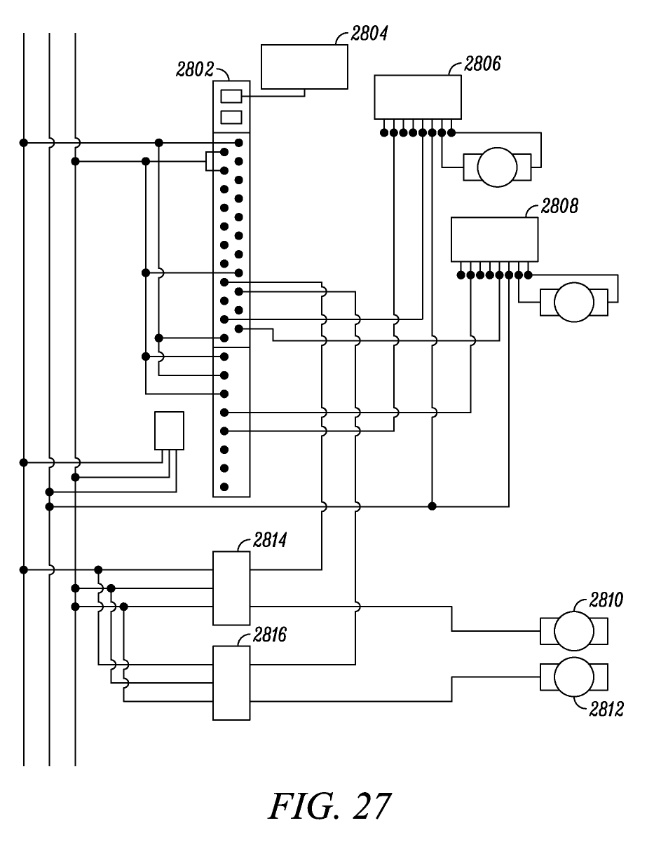

An example of a wiring schematic for a two chip system with separate pumps for each fluid loop is shown in FIG. 27. The system includes a computer 2802 with an operator interface 2804, for inputting the desired function. In preferred embodiments, the computer contains pre-programmed instructions for various tasks such as washing and hybridization on the chips. The interface may include a touch screen, for example, or any other operator input device known in the art, such as a keyboard, number pad, mouse or even voice recognition device, for example. The input device may include operator selected parameters such a pump selection, pump 1, 2806, pump 2, 2808 or both. In addition, the interface may include selections for pre-programmed wash or bind cycles. In certain embodiments when a programmed cycle is running, a display screen indicates certain data such as the name of the cycle, the duration or time remaining or other data such as temperature. In addition to pre-programmed cycles, a preferred embodiment also provides the operator with the option of changing flow rate, temperature and duration of cycles through interactive menus. Also shown in the schematic is the wiring for the two reversing valve motors 2810, 2812, and the respective reversing valve controllers 2814, 2816.

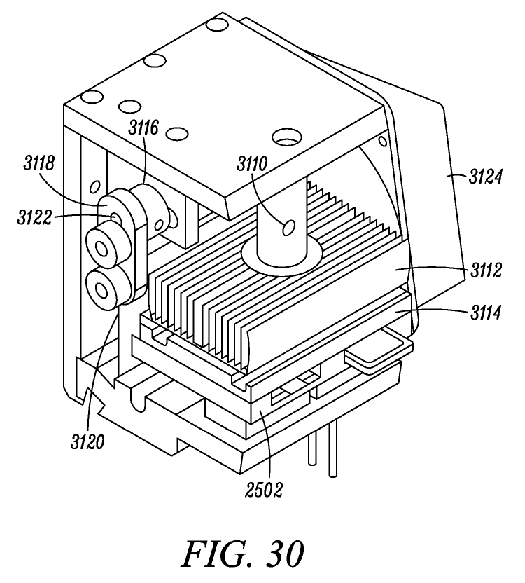

An embodiment of a chip interface sub-assembly is shown in FIG. 30. One or more of such chip interface subassemblies may be disposed within a housing of a hybridization station. In a preferred embodiment, the chip interface subassembly moves in upward and downward directions in order to engage or disengage the chip cartridges from the fluid connections.

In the examples described herein, when a chip cartridge is loaded into a cartridge guide during use, the cartridge is urged down onto the fluid connections by the force of a spring that moves the subassembly down a linear bearing onto the connections. The force of the spring compresses gaskets within the chip cartridge, thus sealing the fluid connections to the system. In preferred embodiments, the heating element, insulating layer and the cartridge guide move as a unit down into the activated position in which the cartridge is connected through the fluid connection posts to the system of pumps and valves that control liquid flow to and away from the chip. The chip is disengaged by an operator activated motive force. In preferred embodiments this force is supplied by a DC gear motor that raises the chip interface subassembly away from the liquid connection posts. It is understood that other methods of raising the chip interface could also be employed, including but not limited to pneumatic, hydraulic or even manual systems. In those systems that require a power source to disengage the chip, a backup, manual release may be provided. Such a release may include a lever configured to engage the spring and compress it to release the cartridge.

The chip interface subassembly is shown in FIG. 30 in the down, or activated position. A compression spring around post 3110 provides the downward force on the heat sink 3112, heating element 3114 and cartridge guide 2502, thus moving the inlet and outlet ports of the chip cartridge onto the fluid posts 2504. The heating element in this embodiment is preferably a thermoelectric element, preferably a computer controlled Peltier heating/cooling element that contacts the chip cartridges through an insulator layer. In preferred embodiments, the insulator provides openings above the chips that allow a portion of the heat block to contact the cartridges in the area directly above the chips and in which areas that are not directly above the cartridges are insulated. The insulating material may be any material known to those of skill in the art, and is preferably a polymeric material such as poly-ether-ether-ketone (“PEEK”) or polypropylene, or it may be any heat insulating material known in the art. Excess heat is removed by the heat sink 3112 and cooling fan 3124. In order to raise the chip cartridge from the fluid connection posts, a DC gear motor 3402 is activated. The motor turns crank 3116 raising the slotted link 3118 and moving the mechanism up the linear bearing 3120. Because of the slot 3122 in link 3118, the motor can only raise, and cannot lower the mechanism. The mechanism is biased to be lowered by the force of the spring unless the DC motor is activated.

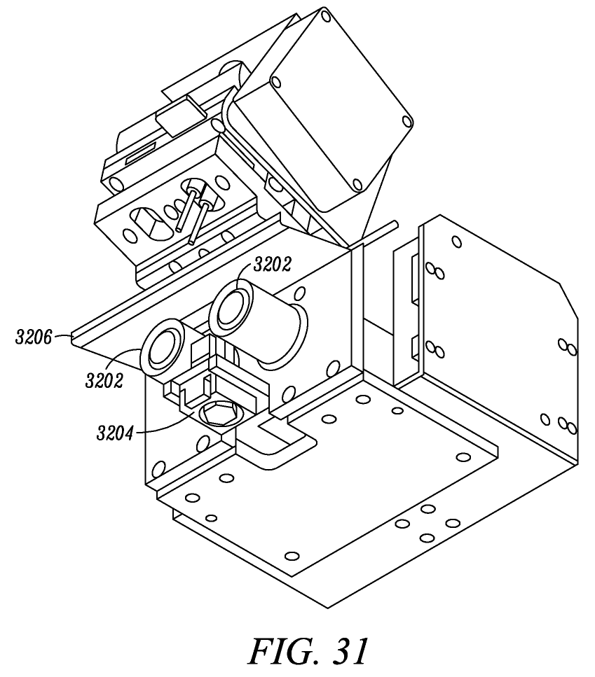

The subassembly below the chip interface subassembly is shown in FIG. 31. In this view, the flow reversing valves 3202 and the peristaltic pump 3204 that control the flow and direction of the fluid can be seen. Also shown in this view are the drip pan 3206.

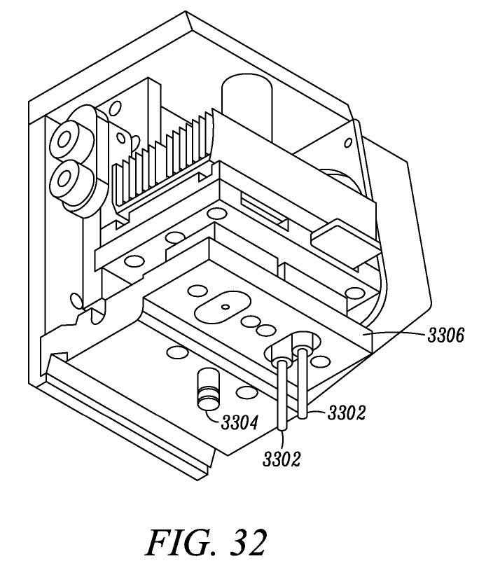

A lower view of the assembly shown in FIG. 30 as it interacts with the fluid post block 3306 is shown in FIG. 32. In this view, the fittings and tubing 3302 that connect the fluid posts to the system of pumps and valves are shown as they exit the fluid post block 3306. Also shown is an inductive proximity sensor 3304 that detects the position of the cartridge guide.

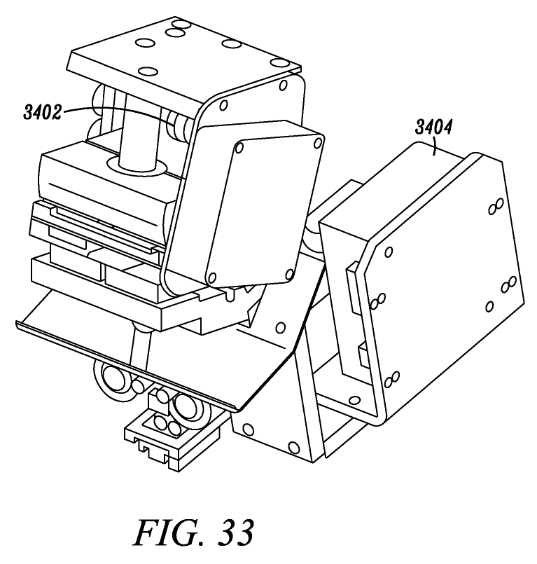

An alternative view of the device shown in the previous figures is shown in FIG. 33. In this view the DC gear motor 3402 can be seen. Also shown is one valve controller 3404. In the two cartridge embodiment shown, the unit includes a second valve controller on the opposite side of the assembly such that two fluid loops including reversing valves are driven by a single peristaltic pump.

While the apparatus and methods disclosed herein have been described in terms of preferred embodiments, it will be apparent to those of skill in the art that variations may be applied to the various apparatus and/or methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

1. Apparatus for delivering fluid to a biochip, the apparatus comprising:
one or more fluid circuits, each comprising:
a first fluid conduit for delivering fluid to a biochip cartridge;
a second fluid conduit for delivering fluid from the biochip cartridge;
a pump for propelling fluid through the circuits; and
a movable chip cartridge interface assembly comprising:
a chip cartridge guide;
a heating/cooling element; and
an inlet port and an outlet port;
wherein, when the chip cartridge interface is in the engaged position during use, the inlet port and outlet port are urged against the inlet conduit and outlet conduit respectively by a spring; and
further wherein the chip cartridge assembly is disengaged from the fluid conduits by compression of the spring.

2. The apparatus of claim 1, further comprising:
a biochip cartridge comprising:
an inlet port for receiving the inlet conduit;
an outlet port for receiving the outlet conduit; and
a gasket seal adjacent each inlet port and each outlet port;
wherein when a chip is placed in the cartridge during use, the inlet port, outlet port and chip form a closed fluid loop.

3. The apparatus of claim 1, wherein the inlet conduit and the outlet conduit comprise probes configured to connect the inlet conduit to the inlet port and the outlet conduit to the outlet port when the chip cartridge assembly is in the engaged position.

4. The apparatus of claim 3, wherein the probes are stainless steel posts.

5. The apparatus of claim 2, wherein at least one of the gaskets includes a filter.

6. The apparatus of claim 5, wherein the filter is a stainless steel frit.

7. The apparatus of claim 1, wherein the first conduit and the second conduit are connected to a reversing valve effective to control the direction of flow of fluid across the biochip.

8. The apparatus of claim 1, where the spring is compressed by a motor to disengage the chip cartridge assembly.

9. The apparatus of claim 8, wherein the motor is connected to a slotted link effective, when the motor is actuated, to move the biochip cartridge assembly against the force of the spring effective to disengage the chip cartridge from the inlet and outlet conduits.

10. The apparatus of claim 8, wherein the motor is a DC gear motor.

11. The apparatus of claim 1, further comprising an inductive proximity switch effective to detect the position of the chip cartridge assembly.

12. The apparatus of claim 1, further comprising one or more fluid reservoirs in fluid communication with the fluid circuits.

13. The apparatus of claim 1, wherein each fluid loop comprises a reservoir, and a reversing valve.

14. The apparatus of claim 1, further comprising a sample holder tray with tube holders and outlet holes for connection of tubing to connect the fluid loops to tubes in the tube holders.

15. The apparatus of claim 1, comprising a master module, and a plurality of fluid loops for delivering fluid to a biochip cartridge and wherein the master module comprises a plurality of reservoirs each connected to a port of a first multiport valve and wherein each fluid loop is connected to a port of a second multiport valve such that fluid from any reservoir connected to the first multiport valve may be delivered to any selected fluid loop.

16. The apparatus of claim 15, wherein each fluid loop comprises a three port valve configured such that fluid may be delivered to two biochip cartridges within each fluid loop.

17. The apparatus of claim 1, further comprising a computer for controlling the pump and heating/cooling element.

18. The apparatus of claim 17, further comprising a user interface connected to the computer.

19. A fluidics station comprising:
a housing;
one or more movable chip cartridge interface assemblies contained within the housing comprising:
a chip cartridge guide configured to hold two chip cartridges;
a heating/cooling element; and
an inlet port and an outlet port;
a plurality of fluid circuits comprising tubing, valves, pumps, and fluid reservoirs configured to deliver fluids to and from the chip cartridges;
a processor to control the delivery of fluids to individual chips and to control the heating/cooling elements; and
a user interface to input commands to the computer;
wherein each movable chip cartridge interface assembly is moveable from an engaged position to a disengaged position;
wherein in the engaged position the chip cartridge is pushed by a spring to engage the fluid circuits through ports in the chip cartridge, wherein each port contains a gasket and in which the pressure of the spring compresses the gasket to form a seal with the fluid circuit;
and further wherein in the disengaged position the chip cartridge is separated from the fluid circuit by compression of the spring.

20. The fluidics station of claim 19, wherein each gasket contains a frit filter embedded in the gasket.

21. A biochip cartridge for processing a microarray on a biochip comprising:
an inlet port for receiving an inlet conduit of a fluidic circuit;
an outlet port for receiving an outlet conduit of a fluidic circuit; and
a gasket seal adjacent each inlet port and each outlet port;
wherein each gasket seal comprises a filter embedded in the gasket; and
further when a chip is placed in the cartridge during use, the inlet port, outlet port and chip form a closed fluid loop.
